(19) United States
(12) Patent Application Publication
(10) Pub. No.: US 2024/0267898 A1
(43) Pub. Date: Aug. 8, 2024

(54) PHYSICAL CHANNEL MAPPING ACROSS FULL-DUPLEX AND NON-FULL-DUPLEX SYMBOLS

(71) Applicant: QUALCOMM Incorporated, San Diego, CA (US)

(72) Inventors: Muhammad Sayed Khairy ABDELGHAFFAR, San Jose, CA (US); Gokul SRIDHARAN, Sunnyvale, CA (US); Kianoush HOSSEINI, San Diego, CA (US); Hung Dinh LY, San Diego, CA (US); Qian ZHANG, Basking Ridge, NJ (US); Yi HUANG, San Diego, CA (US)

(21) Appl. No.: 18/414,793

(22) Filed: Jan. 17, 2024

Related U.S. Application Data
(60) Provisional application No. 63/483,380, filed on Feb. 6, 2023.

(51) Int. Cl. H04W 72/0446; H04L 1/00; H04L 5/14; H04L 27/26

(52) U.S. Cl. CPC H04W 72/0446; H04L 1/0067; H04L 5/14; H04L 27/2605

(57) ABSTRACT

Various aspects of the present disclosure generally relate to wireless communication. In some aspects, a user equipment (UE) may receive, from a network, a time domain resource allocation associated with a physical channel that is mapped only to symbols associated with a full-duplex mode or only to symbols associated with a non-full-duplex mode in a slot. Alternatively, the UE may receive, from the network, a time domain resource allocation associated with a physical channel that is mapped only to symbols associated with a full-duplex mode or only to symbols associated with a non-full-duplex mode in a slot. The UE may further communicate with the network using the physical channel. Numerous other aspects are described.

### CROSS-REFERENCE TO RELATED APPLICATION

This patent application claims priority to U.S. Provisional Patent Application No. 63/483,380, filed on Feb. 6, 2023, entitled “PHYSICAL CHANNEL MAPPING ACROSS FULL-DUPLEX AND NON-FULL-DUPLEX SYMBOLS,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for mapping physical channels across full-duplex and non-full-duplex symbols.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a user equipment (UE). The apparatus may include a memory and one or more processors coupled to the memory. The one or more processors may be configured to receive, from a network, a time domain resource allocation associated with a physical channel that is mapped only to symbols associated with a full-duplex mode or only to symbols associated with a non-full-duplex mode in a slot. The one or more processors may be configured to communicate with the network using the physical channel.

Some aspects described herein relate to an apparatus for wireless communication at a network node. The apparatus may include a memory and one or more processors coupled to the memory. The one or more processors may be configured to transmit a time domain resource allocation associated with a physical channel that is mapped only to symbols associated with a full-duplex mode or only to symbols associated with a non-full-duplex mode in a slot. The one or more processors may be configured to communicate with a UE using the physical channel.

Some aspects described herein relate to an apparatus for wireless communication at a UE. The apparatus may include a memory and one or more processors coupled to the memory. The one or more processors may be configured to receive, from a network, a time domain resource allocation associated with a physical channel that is mapped to a combination of symbols associated with a full-duplex mode and symbols associated with a non-full-duplex mode in a slot. The one or more processors may be configured to communicate with the network using the physical channel.

Some aspects described herein relate to an apparatus for wireless communication at a network node. The apparatus may include a memory and one or more processors coupled to the memory. The one or more processors may be configured to transmit a time domain resource allocation associated with a physical channel that is mapped to a combination of symbols associated with a full-duplex mode and symbols associated with a non-full-duplex mode in a slot. The one or more processors may be configured to communicate with a UE using the physical channel.

Some aspects described herein relate to a method of wireless communication performed by a UE. The method may include receiving, from a network, a time domain resource allocation associated with a physical channel that is mapped only to symbols associated with a full-duplex mode or only to symbols associated with a non-full-duplex mode in a slot. The method may include communicating with the network using the physical channel.

Some aspects described herein relate to a method of wireless communication performed by a network node. The method may include transmitting a time domain resource allocation associated with a physical channel that is mapped only to symbols associated with a full-duplex mode or only to symbols associated with a non-full-duplex mode in a slot. The method may include communicating with a UE using the physical channel.

Some aspects described herein relate to a method of wireless communication performed by a UE. The method may include receiving, from a network, a time domain resource allocation associated with a physical channel that is mapped to a combination of symbols associated with a full-duplex mode and symbols associated with a non-full-duplex mode in a slot. The method may include communicating with the network using the physical channel.

Some aspects described herein relate to a method of wireless communication performed by a network node. The method may include transmitting a time domain resource allocation associated with a physical channel that is mapped to a combination of symbols associated with a full-duplex mode and symbols associated with a non-full-duplex mode in a slot. The method may include communicating with a UE using the physical channel.

Some aspects described herein relate to a non-transitory computer-readable medium that stores a set of instructions for wireless communication by a UE. The set of instructions, when executed by one or more processors of the UE, may cause the UE to receive, from a network, a time domain resource allocation associated with a physical channel that is mapped only to symbols associated with a full-duplex mode or only to symbols associated with a non-full-duplex mode in a slot. The set of instructions, when executed by one or more processors of the UE, may cause the UE to communicate with the network using the physical channel.

Some aspects described herein relate to a non-transitory computer-readable medium that stores a set of instructions for wireless communication by a network node. The set of instructions, when executed by one or more processors of the network node, may cause the network node to transmit a time domain resource allocation associated with a physical channel that is mapped only to symbols associated with a full-duplex mode or only to symbols associated with a non-full-duplex mode in a slot. The set of instructions, when executed by one or more processors of the network node, may cause the network node to communicate with a UE using the physical channel.

Some aspects described herein relate to a non-transitory computer-readable medium that stores a set of instructions for wireless communication by a UE. The set of instructions, when executed by one or more processors of the UE, may cause the UE to receive, from a network, a time domain resource allocation associated with a physical channel that is mapped to a combination of symbols associated with a full-duplex mode and symbols associated with a non-full-duplex mode in a slot. The set of instructions, when executed by one or more processors of the UE, may cause the UE to communicate with the network using the physical channel.

Some aspects described herein relate to a non-transitory computer-readable medium that stores a set of instructions for wireless communication by a network node. The set of instructions, when executed by one or more processors of the network node, may cause the network node to transmit a time domain resource allocation associated with a physical channel that is mapped to a combination of symbols associated with a full-duplex mode and symbols associated with a non-full-duplex mode in a slot. The set of instructions, when executed by one or more processors of the network node, may cause the network node to communicate with a UE using the physical channel.

Some aspects described herein relate to an apparatus for wireless communication. The apparatus may include means for receiving, from a network, a time domain resource allocation associated with a physical channel that is mapped only to symbols associated with a full-duplex mode or only to symbols associated with a non-full-duplex mode in a slot. The apparatus may include means for communicating with the network using the physical channel.

Some aspects described herein relate to an apparatus for wireless communication. The apparatus may include means for transmitting a time domain resource allocation associated with a physical channel that is mapped only to symbols associated with a full-duplex mode or only to symbols associated with a non-full-duplex mode in a slot. The apparatus may include means for communicating with a UE using the physical channel.

Some aspects described herein relate to an apparatus for wireless communication. The apparatus may include means for receiving, from a network, a time domain resource allocation associated with a physical channel that is mapped to a combination of symbols associated with a full-duplex mode and symbols associated with a non-full-duplex mode in a slot. The apparatus may include means for communicating with the network using the physical channel.

Some aspects described herein relate to an apparatus for wireless communication. The apparatus may include means for transmitting a time domain resource allocation associated with a physical channel that is mapped to a combination of symbols associated with a full-duplex mode and symbols associated with a non-full-duplex mode in a slot. The apparatus may include means for communicating with a UE using the physical channel.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment in a wireless network, in accordance with the present disclosure.

FIG. 3 is a diagram illustrating an example disaggregated base station architecture, in accordance with the present disclosure.

FIG. 4 is a diagram illustrating examples of full-duplex communication in a wireless network, in accordance with the present disclosure.

FIG. 5 is a diagram illustrating an example of subband full-duplex activation, in accordance with the present disclosure.

FIGS. 6 and 7 are diagrams illustrating examples associated with time domain resource allocations for a physical channel in a slot with full-duplex symbols and non-full-duplex symbols, in accordance with the present disclosure.

FIG. 8 is a diagram illustrating an example associated with a guard period in a slot with full-duplex symbols and non-full-duplex symbols, in accordance with the present disclosure.

FIG. 9 is a diagram illustrating an example associated with frequency hopping in a slot with full-duplex symbols and non-full-duplex symbols, in accordance with the present disclosure.

FIG. 10 is a diagram illustrating an example associated with Type B repetition in a slot with full-duplex symbols and non-full-duplex symbols, in accordance with the present disclosure.

FIG. 11 is a diagram illustrating an example associated with a time domain window in a slot with full-duplex symbols and non-full-duplex symbols, in accordance with the present disclosure.

FIGS. 12 and 13 are diagrams illustrating examples associated with frequency domain resource allocations in a slot with full-duplex symbols and non-full-duplex symbols, in accordance with the present disclosure.

FIGS. 14, 15, 16, and 17 are diagrams illustrating example processes associated with mapping physical channels across full-duplex and non-full-duplex symbols, in accordance with the present disclosure.

FIGS. 18 and 19 are diagrams of example apparatuses for wireless communication, in accordance with the present disclosure.

### DETAILED DESCRIPTION

Various aspects relate generally to wireless communication and more particularly to full-duplex modes (e.g., subband full-duplex (SBFD)). Some aspects more specifically relate to ignoring a time domain resource allocation (TDRA) for a physical channel that maps to a combination of symbols associated with a full-duplex mode and symbols associated with a non-full-duplex mode. For example, a network may refrain from transmitting a TDRA for a physical channel that maps to a combination of full-duplex symbols and non-full-duplex symbols in a single slot. A UE may thus perform timing adjustments, filter changes, radio frequency (RF) retuning, beam changes, and/or other types of transmission or reception parameter adjustments when transitioning between full-duplex symbols and non-full-duplex symbols within the slot. Alternatively, some aspects more specifically relate to communicating on a physical channel associated with a TDRA that maps to a combination of symbols associated with a full-duplex mode and symbols associated with a non-full-duplex mode. For example, a network may schedule a communication across the combination with a same frequency domain resource allocation (FDRA) and a same spatial relation or transmission configuration indicator (TCI) state. As a result, a UE may receive a larger communication using the combination of symbols.

Particular aspects of the subject matter described in this disclosure can be implemented to realize one or more of the following potential advantages. For example, ignoring a TDRA for a physical channel that maps to a combination of full-duplex symbols and non-full-duplex symbols in a single slot enables the UE to perform transmission or reception parameter adjustments when transitioning between full-duplex symbols and non-full-duplex symbols within the slot. As a result, the UE experiences increased quality and reliability of communications because the UE uses more optimal transmission or reception parameters after transitioning. Additionally, the UE conserves power and processing resources that otherwise would have been wasted on failed decoding attempts and/or retransmissions after transitioning. Alternatively, communicating on a physical channel associated with a TDRA that maps to a combination of full-duplex symbols and non-full-duplex symbols in a single slot enables the UE to receive larger communications on the physical channel. As a result, the UE experiences increased throughput because the physical channel maps to additional symbols in the slot. Additionally, the UE experiences reduced latency because larger communications are schedule in the slot rather than in a subsequent slot.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

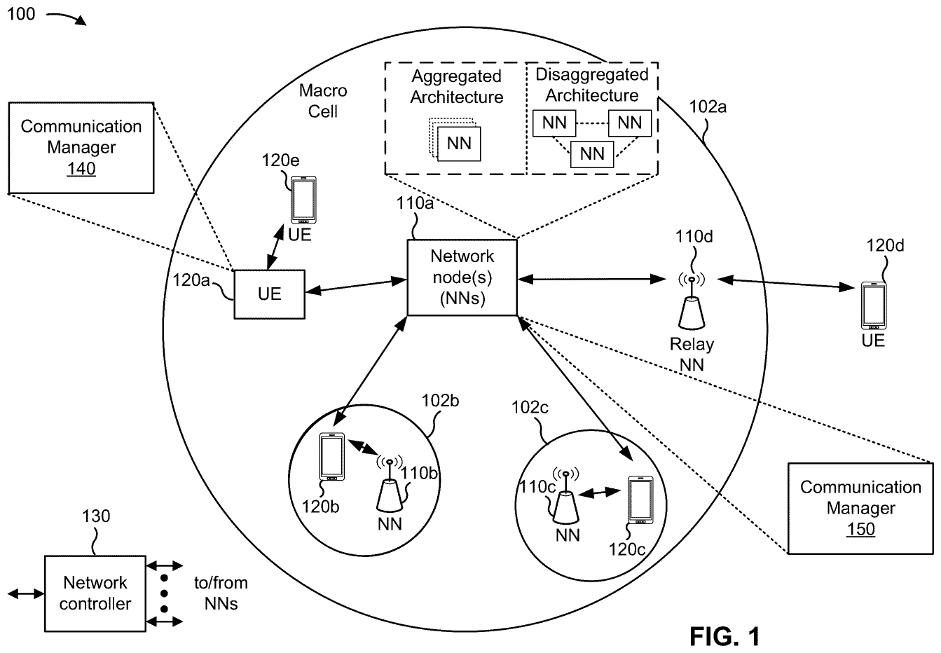

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an NB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (cMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive (e.g., from the network node 110) a time domain resource allocation associated with a physical channel that is mapped only to symbols associated with a full-duplex mode or only to symbols associated with a non-full-duplex mode in a slot and may communicate (e.g., with the network node 110) using the physical channel. Alternatively, the communication manager 140 may receive (e.g., from the network node 110) a time domain resource allocation associated with a physical channel that is mapped to a combination of symbols associated with a full-duplex mode and symbols associated with a non-full-duplex mode in a slot and may communicate (e.g., with the network node 110) using the physical channel. Additionally, or alternatively, the communication manager 140 may perform one or more other operations described herein.

In some aspects, the network node 110 may include a communication manager 150. As described in more detail elsewhere herein, the communication manager 150 may transmit a time domain resource allocation associated with a physical channel that is mapped only to symbols associated with a full-duplex mode or only to symbols associated with a non-full-duplex mode in a slot and may communicate (e.g., with the UE 120) using the physical channel. Alternatively, the communication manager 150 may transmit a time domain resource allocation associated with a physical channel that is mapped to a combination of symbols associated with a full-duplex mode and symbols associated with a non-full-duplex mode in a slot and may communicate (e.g., with the UE 120) using the physical channel. Additionally, or alternatively, the communication manager 150 may perform one or more other operations described herein.

As indicated above, FIG. 1 is provided as an example. Other examples may differ from what is described with regard to FIG. 1.

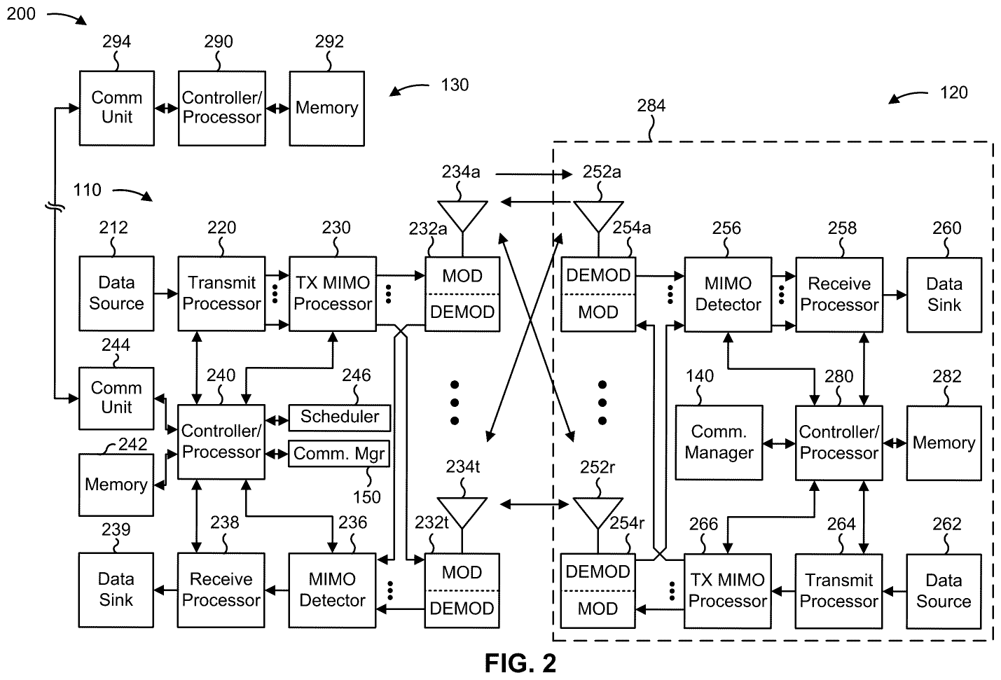

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

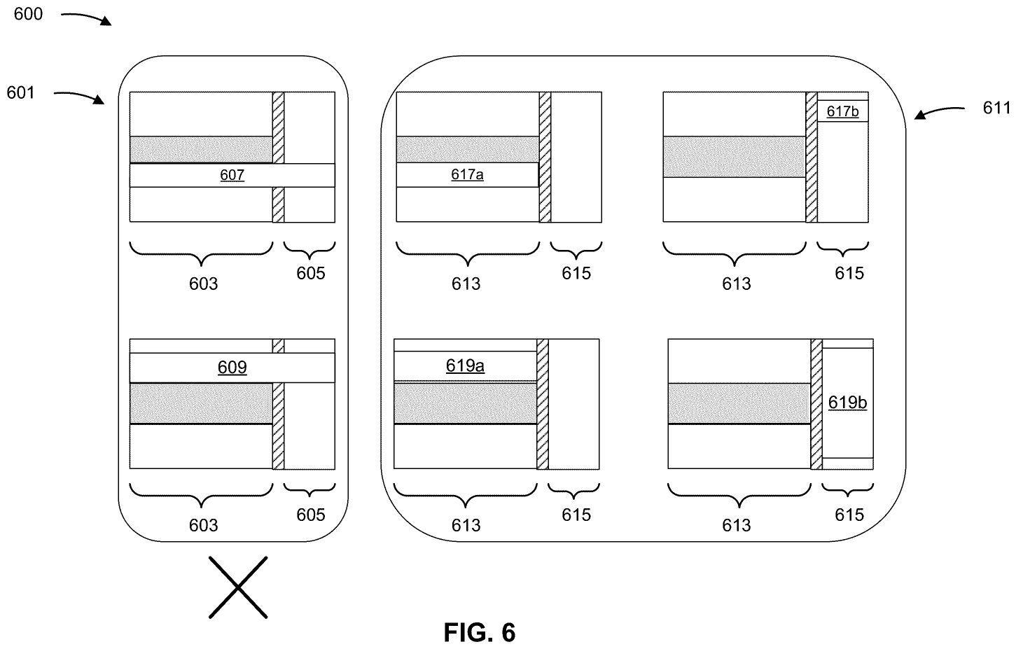

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-19).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-19).

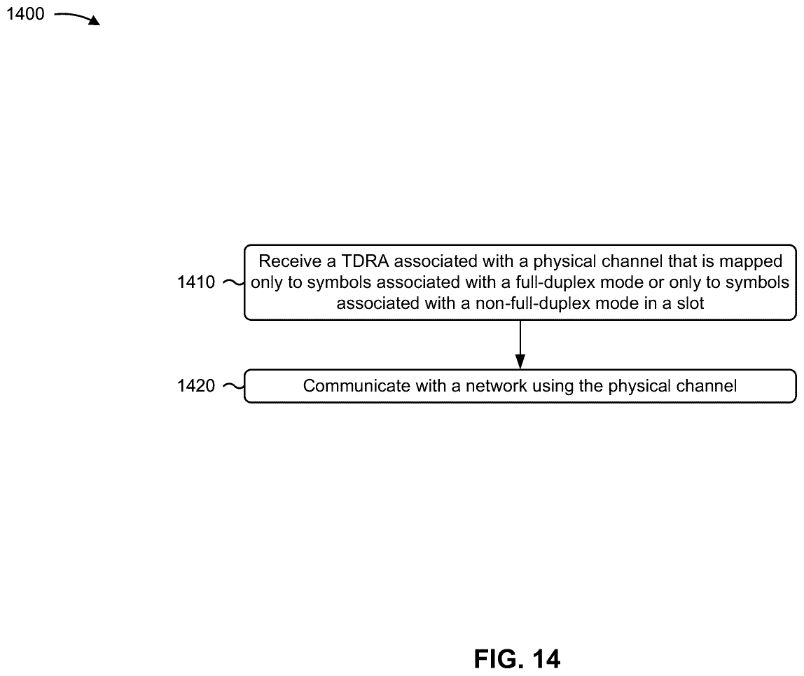

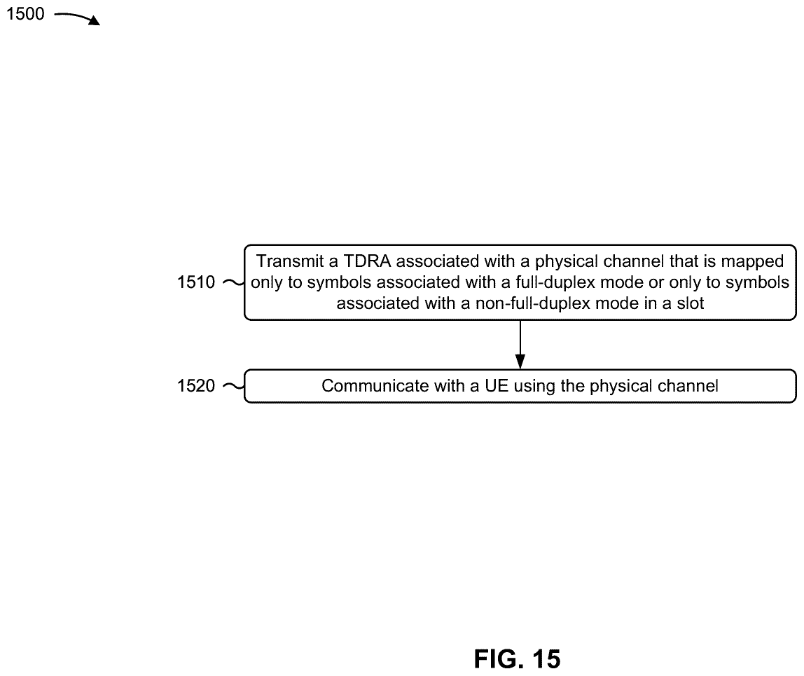

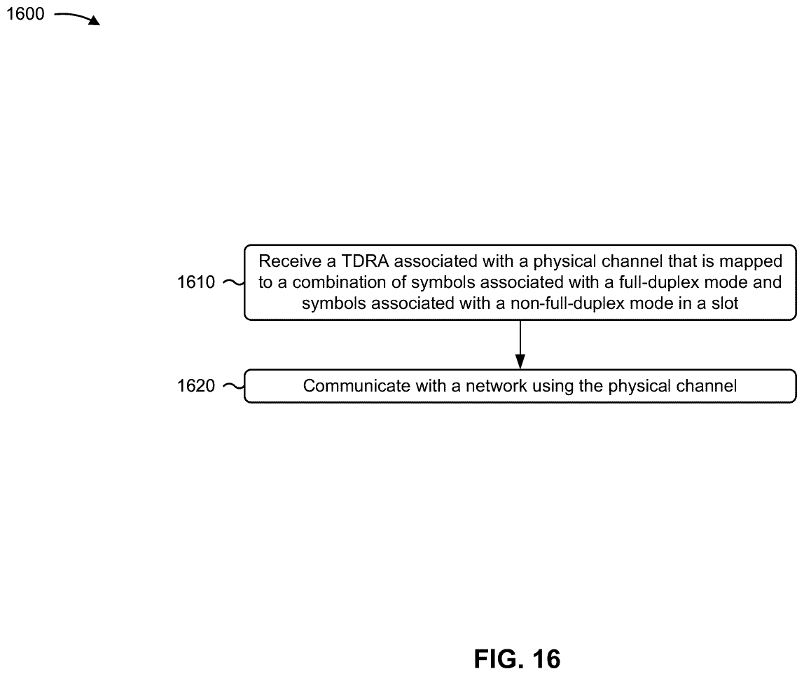

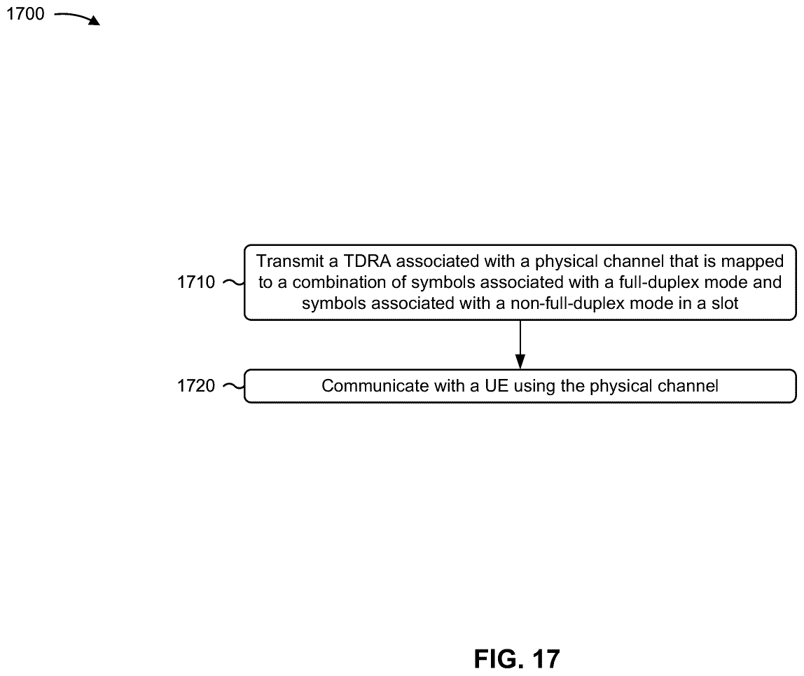

The controller/processor 240 of the network node 110, the controller/processor 280 of the UE 120, and/or any other component(s) of FIG. 2 may perform one or more techniques associated with mapping physical channels across full-duplex and non-full-duplex symbols, as described in more detail elsewhere herein. For example, the controller/processor 240 of the network node 110, the controller/processor 280 of the UE 120, and/or any other component(s) of FIG. 2 may perform or direct operations of, for example, process 1400 of FIG. 14, process 1500 of FIG. 15, process 1600 of FIG. 16, process 1700 of FIG. 17, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1400 of FIG. 14, process 1500 of FIG. 15, process 1600 of FIG. 16, process 1700 of FIG. 17, and/or other processes as described herein. In some examples, executing instructions may include running the instructions, converting the instructions, compiling the instructions, and/or interpreting the instructions, among other examples.

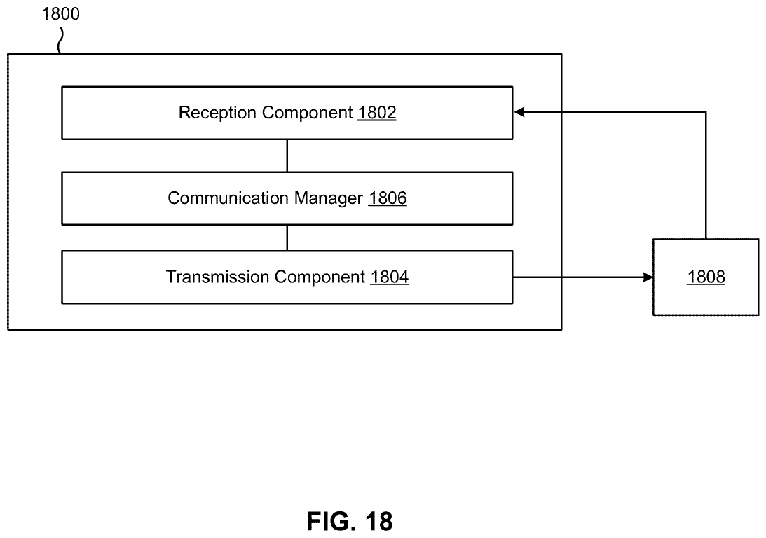

In some aspects, a UE (e.g., the UE 120 and/or apparatus 1800 of FIG. 18) may include means for receiving, from a network, a time domain resource allocation associated with a physical channel that is mapped only to symbols associated with a full-duplex mode or only to symbols associated with a non-full-duplex mode in a slot and/or means for communicating with the network using the physical channel. Alternatively, the UE may include means for receiving, from a network, a time domain resource allocation associated with a physical channel that is mapped to a combination of symbols associated with a full-duplex mode and symbols associated with a non-full-duplex mode in a slot and/or means for communicating with the network using the physical channel. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

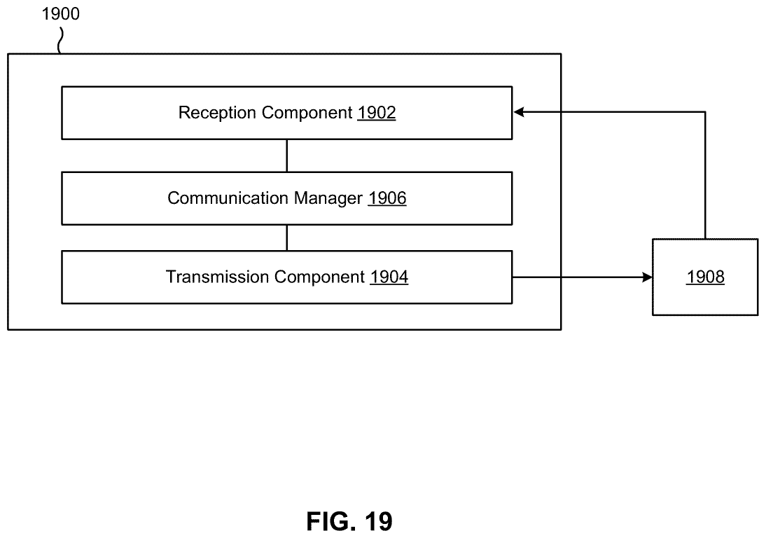

In some aspects, a network node (e.g., the network node 110, an RU 340, a DU 330, a CU 310, and/or apparatus 1900 of FIG. 19) may include means for transmitting a time domain resource allocation associated with a physical channel that is mapped only to symbols associated with a full-duplex mode or only to symbols associated with a non-full-duplex mode in a slot and/or means for communicating with a UE using the physical channel. Alternatively, the network node may include means for transmitting a time domain resource allocation associated with a physical channel that is mapped to a combination of symbols associated with a full-duplex mode and symbols associated with a non-full-duplex mode in a slot and/or means for communicating with a UE using the physical channel. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

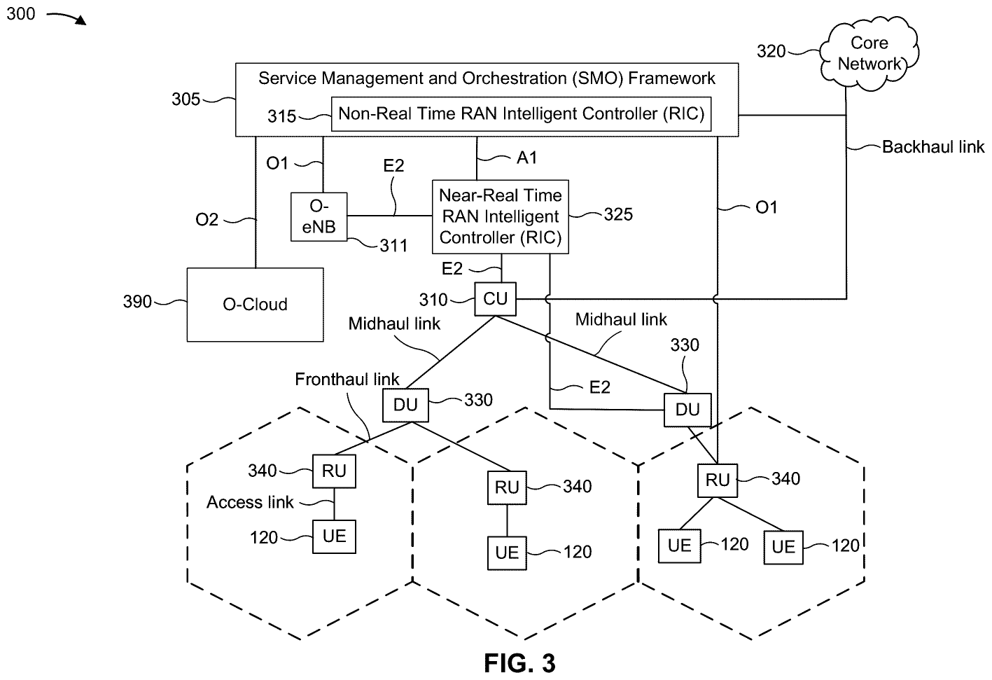

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through FI interfaces. Each of the DUs 330 may communicate with one or more RUs 340 via respective fronthaul links. Each of the RUs 340 may communicate with one or more UEs 120 via respective RF access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

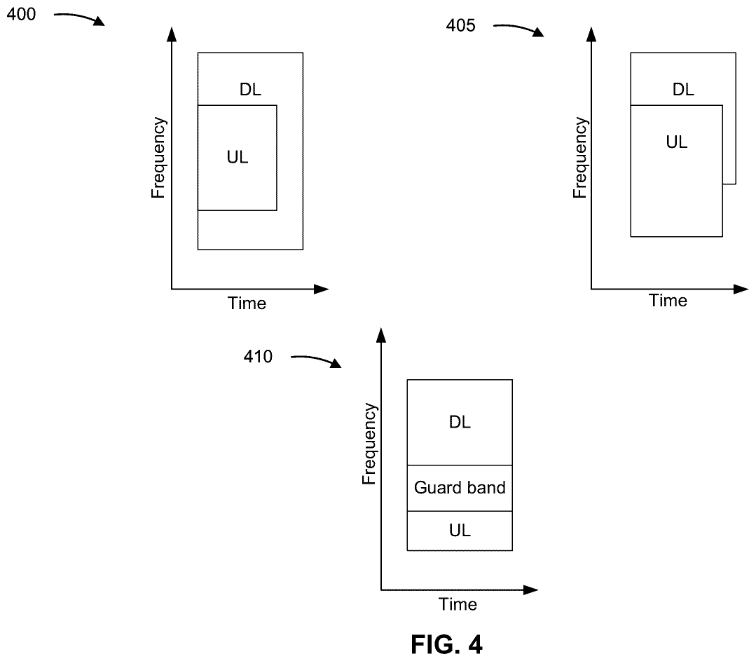

FIG. 4 is a diagram illustrating examples 400, 405, and 410 of full-duplex communication in a wireless network, in accordance with the present disclosure. “Full-duplex communication” in a wireless network refers to simultaneous bi-directional communication between devices in the wireless network. For example, a device operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol).

As shown in FIG. 4, examples 400 and 405 show examples of in-band full-duplex (IBFD) communication. In IBFD, a device may transmit an uplink communication to a network node and receive a downlink communication from the network node on the same time and frequency resources. As shown in example 400, in a first example of IBFD, the time and frequency resources for uplink communication may fully overlap with the time and frequency resources for downlink communication. As shown in example 405, in a second example of IBFD, the time and frequency resources for uplink communication may partially overlap with the time and frequency resources for downlink communication.

As further shown in FIG. 4, example 410 shows an example of SBFD communication, which may also be referred to as “subband frequency division duplex (SBFDD)” or “flexible duplex.” In SBFD, a device may transmit an uplink communication to a network node and receive a downlink communication from the network node at the same time, but on different frequency resources. For example, the different frequency resources may be subbands of a frequency band, such as a time division duplexing band. In this case, the frequency resources used for downlink communication may be separated from the frequency resources used for uplink communication, in the frequency domain, by a guard band.

In examples 400, 405, and 410, a downlink (DL) bandwidth part (BWP) and an uplink (UL) BWP can be active at the same time. Therefore, a UE (and a corresponding network node) may transmit and receive simultaneously (or at least partially overlapping in time).

As indicated above, FIG. 4 is provided as an example. Other examples may differ from what is described with respect to FIG. 4.

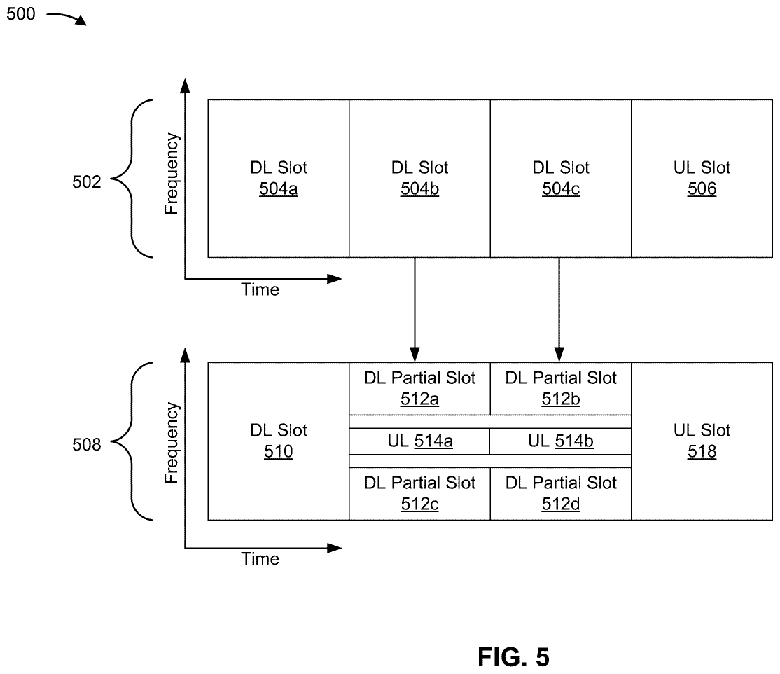

FIG. 5 is a diagram illustrating an example 500 of SBFD activation, in accordance with the present disclosure. As shown in FIG. 5, example 500 includes a first configuration 502. In some aspects, the first configuration 502 may indicate a first slot format pattern (sometimes called a time division duplexing (TDD) pattern) associated with a half-duplex mode or a full-duplex mode. The first slot format pattern may include a quantity of downlink slots (e.g., three downlink slots 504a, 504b, and 504c, as shown), a quantity of flexible slots (not shown), and/or a quantity of uplink slots (e.g., one uplink slot 506, as shown). The first slot format pattern may repeat over time. In some aspects, a network node may indicate the first slot format pattern to a UE using one or more slot format indicators (SFIs). An SFI, for a slot, may indicate whether that slot is an uplink slot, a downlink slot, or a flexible slot, among other examples. As used herein, “slot” may refer to a portion of a subframe, which in turn may be a fraction of a radio frame within an LTE, 5G, or other wireless communication structure. In some aspects, a slot may include one or more symbols. Additionally, “symbol” may refer to an OFDM symbol or another similar symbol within a slot.

A network node may instruct (e.g., using an indication, such as an RRC message, a MAC control element (MAC-CE), or downlink control information (DCI)) a UE to switch from the first configuration 502 to a second configuration 508. As an alternative, the UE may indicate to the network node that the UE is switching from the first configuration 502 to the second configuration 508. The second configuration 508 may indicate a second slot format pattern that repeats over time, similar to the first slot format pattern. In any of the aspects described above, the UE may switch from the first configuration 502 to the second configuration 508 during a time period (e.g., a quantity of symbols and/or an amount of time, such as milliseconds (ms)) based at least in part on an indication received from the network node (e.g., before switching back to the first configuration 502). During that time period, the UE may communicate using the second slot format pattern, and then may revert to using the first slot format pattern after the end of the time period. The time period may be indicated by the network node (e.g., in the instruction to switch from the first configuration 502 to the second configuration 508, as described above) and/or based at least in part on a programmed and/or otherwise preconfigured rule. For example, the rule may be based at least in part on a table (e.g., defined in 3GPP specifications and/or another wireless communication standard) that associates different sub-carrier spacings (SCSs) and/or numerologies (e.g., represented by u and associated with corresponding SCSs) with corresponding time periods for switching configurations.

In example 500, the second slot format pattern includes two SBFD slots in place of what were downlink slots in the first slot format pattern. In example 500, each SBFD slot includes a partial slot (e.g., a portion or subband of a frequency allocated for use by the network node and the UE) for downlink (e.g., partial slots 512a, 512b, 512c, and 512d, as shown) and a partial slot for uplink (e.g., partial slots 514a and 514b, as shown). The second configuration 508 further includes a downlink slot 510 and an uplink slot 518. Accordingly, the UE may operate using the second slot format pattern to transmit an uplink communication in an earlier slot (e.g., the second slot in sequence, shown as partial UL slot 514a) as compared to using the first slot format pattern (e.g., the fourth slot in sequence, shown as UL slot 506). Other examples may include additional or alternative changes. For example, the second configuration 508 may indicate an SBFD slot in place of what was an uplink slot in the first configuration 502 (e.g., UL slot 506). In another example, the second configuration 508 may indicate a downlink slot or an uplink slot in place of what was an SBFD slot in the first configuration 502 (not shown in FIG. 5). In yet another example, the second configuration 508 may indicate a downlink slot or an uplink slot in place of what was an uplink slot or a downlink slot, respectively, in the first configuration 502. An “SBFD slot” may refer to a slot in which an SBFD format is used. An SBFD format may include a slot format in which full duplex communication is supported (e.g., for both uplink and downlink communications), with one or more frequencies used for an uplink portion of the slot being separated from one or more frequencies used for a downlink portion of the slot by a guard band. In some aspects, the SBFD format may include a single uplink portion and a single downlink portion separated by a guard band. In some aspects, the SBFD format may include multiple downlink portions and a single uplink portion that is separated from the multiple downlink portions by respective guard bands (e.g., as shown in FIG. 5). In some aspects, an SBFD format may include multiple uplink portions and a single downlink portion that is separated from the multiple uplink portions by respective guard bands. In some aspects, the SBFD format may include multiple uplink portions and multiple downlink portions, where each uplink portion is separated from a downlink portion by a guard band. In some aspects, operating using an SBFD mode may include activating or using a full-duplex mode in one or more slots based at least in part on the one or more slots having the SBFD format. A slot may support the SBFD mode if an UL BWP and a DL BWP are permitted to be or are simultaneously active in the slot in an SBFD fashion (e.g., with guard band separation).

By switching from the first configuration 502 to the second configuration 508, the network node and the UE may experience increased quality and/or reliability of communications. For example, the network node and the UE may experience increased throughput (e.g., using a full-duplex mode), reduced latency (e.g., the UE may be able to transmit an uplink and/or a downlink communication sooner using the second configuration 508 rather than the first configuration 502), and increased network resource utilization (e.g., by using both the DL BWP and the UL BWP simultaneously instead of only the DL BWP or the UL BWP).

In some configurations, a single slot may include one or more symbols that are configured for a full-duplex mode (e.g., SBFD) and one or more symbols that are configured for a non-full-duplex mode (e.g., non-SBFD). A physical channel may be scheduled (e.g., using a TDRA and an FDRA) within the single slot.

Some techniques and apparatuses described herein enable a UE (e.g., UE 120) to discard a TDRA for a physical channel that maps to a combination of symbols associated with a full-duplex mode and symbols associated with a non-full-duplex mode. Accordingly, the UE 120 may perform timing adjustments, filter changes, RF retuning, beam changes, and/or other types of transmission or reception parameter adjustments when transitioning between full-duplex symbols and non-full-duplex symbols within a slot. As a result, the UE 120 experiences increased quality and reliability of communications and thus conserves power and processing resources that otherwise would have been wasted on failed decoding attempts and/or retransmissions.

Alternatively, some techniques and apparatuses described herein enable a UE (e.g., UE 120) to communicate on a physical channel associated with a TDRA that maps to a combination of symbols associated with a full-duplex mode and symbols associated with a non-full-duplex mode. For example, a network may schedule a communication across the combination with a same FDRA and a same spatial relation or TCI state. As a result, the UE 120 experiences increased throughput because the physical channel maps to additional symbols in the slot.

As indicated above, FIG. 5 is provided as an example. Other examples may differ from what is described with respect to FIG. 5.

FIG. 6 is a diagram illustrating an example 600 associated with TDRAs for a physical channel in a slot with full-duplex symbols and non-full-duplex symbols, in accordance with the present disclosure. As shown in FIG. 6, example 600 includes a set of TDRAs 601 that are disallowed and a set of TDRAs 611 that are allowed.

As shown in FIG. 6, a TDRA associated with a physical channel that is mapped to a combination of symbols associated with the full-duplex mode and symbols associated with the non-full-duplex mode is disallowed. In other words, a UE (e.g., UE 120) does not expect a physical channel to be mapped across symbols in a same slot with different duplex modes (e.g., SBFD and non-SBFD). Similarly, a network (e.g., via an RU 340 and/or a device controlling the RU 340, such as a DU 330 or a CU 310) refrains from mapping a physical channel across symbols in a same slot with different duplex modes (e.g., SBFD and non-SBFD).

In the set of TDRAs 601 that are disallowed, FIG. 6 depicts a single slot with one or more symbols 603 that are associated with SBFD and one or more symbols 605 that are associated with non-SBFD. An uplink physical channel 607 (e.g., a physical uplink control channel (PUCCH) or a physical uplink shared channel (PUSCH)) is disallowed from mapping to a combination of the symbol(s) 603 and the symbol(s) 605. Similarly, a downlink channel 609 (e.g., a physical downlink control channel (PDCCH) or a physical downlink shared channel (PDSCH)) is disallowed from mapping to a combination of the symbol(s) 603 and the symbol(s) 605.

In the set of TDRAs 611 that are allowed, FIG. 6 depicts a single slot with one or more symbols 613 that are associated with SBFD and one or more symbols 615 that are associated with non-SBFD. An uplink channel 617a is mapped to the symbol(s) 613 while an uplink channel 617b is mapped to the symbol(s) 615. Therefore, the UE 120 may transmit a communication to the network using the physical channels 617a and 617b. Similarly, a downlink channel 619a is mapped to the symbol(s) 613 while a downlink channel 619b is mapped to the symbol(s) 615. Therefore, the UE 120 may receive a communication from the network using the physical channels 619a and 619b.

Although the example 600 is shown with the full-duplex symbols preceding the non-full-duplex symbols, other examples may include a slot in which non-full-duplex symbols precede-full-duplex symbols.

By using techniques as described in connection with FIG. 6, the UE 120 may perform timing adjustments, filter changes, RF retuning, beam changes, and/or other types of transmission or reception parameter adjustments when transitioning between the symbol(s) 613 and the symbol(s) 615 in a slot. As a result, the UE 120 experiences increased quality and reliability of communications and thus conserves power and processing resources that otherwise would have been wasted on failed decoding attempts and/or retransmissions.

As indicated above, FIG. 6 is provided as an example. Other examples may differ from what is described with respect to FIG. 6.

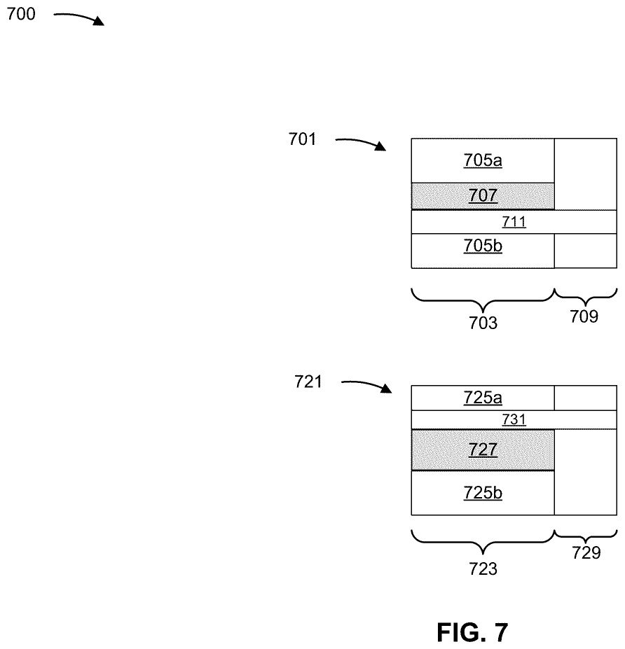

FIG. 7 is a diagram illustrating an example 700 associated with TDRAs for a physical channel in a slot with full-duplex symbols and non-full-duplex symbols, in accordance with the present disclosure. As shown in FIG. 7, example 700 includes an example TDRA 701 and an example TDRA 721.

The example TDRA 701 is depicted for a single slot with one or more symbols 703 that are associated with SBFD. As shown in FIG. 7, the symbol(s) 703 include a first subband 705a associated with downlink, a second subband 705b also associated with downlink, and a third subband 707 associated with uplink. Other examples may include additional or fewer subbands associated with downlink and/or additional subbands associated with uplink. The example TDRA 701 further includes one or more symbols 709 that are associated with non-SBFD. The symbol(s) 709 may be associated with uplink.

As further shown in FIG. 7, an uplink channel 711 (e.g., a PUCCH or a PUSCH) may be mapped to a combination of the symbol(s) 703 and the symbol(s) 709. For example a network (e.g., via an RU 340 and/or a device controlling the RU 340, such as a DU 330 or a CU 310) may transmit an RRC message, a MAC-CE, and/or DCI that maps the physical channel 711 across the symbol(s) 703 and the symbol(s) 709. The network may use a configured grant (CG) (e.g., configured via RRC and activated via MAC-CE or DCI) or a dynamic grant (DG) to indicate the TDRA for the physical channel 711.

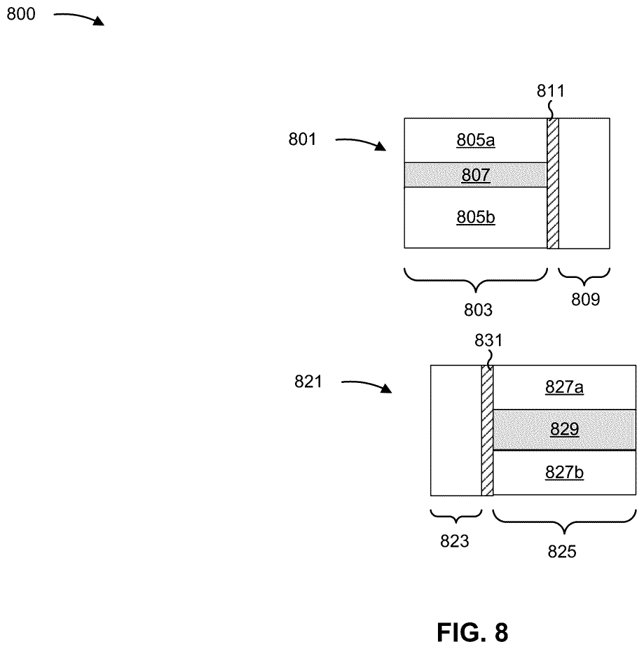

In some aspects, as shown in FIG. 7, a time period between the symbol(s) 703 and the symbol(s) 709 may be null. As used herein, a “null” time period refers to a non-existent time gap. In other words, there may be no time gap between the symbol(s) 703 and the symbol(s) 709. As a result, there is no change in a timing advance (TA). Alternatively, the physical channel 711 may be mapped to one or more guard symbols (e.g., as described in connection with FIG. 8).

In some aspects, as further shown in FIG. 7, the symbol(s) 703 are associated with a same frequency resource allocation as the symbol(s) 709. For example, the network may indicate a same FDRA for a portion of the physical channel 711 mapped to the symbol(s) 703 as for a portion of the physical channel 711 mapped to the symbol(s) 709. Accordingly, in the example 700, a same narrow resource allocation used in the SBFD symbol(s) 703 is used in the non-SBFD symbol(s) 709. As a result, the UE 120 may maintain phase coherency while transmitting on the physical channel 711, which improves quality and reliability of communications on the physical channel 711.

In some aspects, the symbol(s) 703 are associated with same spatial relation information as the symbol(s) 709. Accordingly, the UE 120 uses a same uplink beam when transmitting in a portion of the physical channel 711 mapped to the symbol(s) 703 as in a portion of the physical channel 711 mapped to the symbol(s) 709. Additionally, the UE 120 may use a same transmit power across the physical channel 711.

Similarly, the example TDRA 721 is depicted for a single slot with one or more symbols 723 that are associated with SBFD. As shown in FIG. 7, the symbol(s) 723 include a first subband 725a associated with downlink, a second subband 725b also associated with downlink, and a third subband 727 associated with uplink. Other examples may include additional or fewer subbands associated with downlink and/or additional subbands associated with uplink. The example TDRA 721 further includes one or more symbols 729 that are associated with non-SBFD. The symbol(s) 729 may be associated with downlink.

As further shown in FIG. 7, a downlink channel 731 (e.g., a PDCCH or a PDSCH) may be mapped to a combination of the symbol(s) 723 and the symbol(s) 729. For example a network (e.g., via an RU 340 and/or a device controlling the RU 340, such as a DU 330 or a CU 310) may transmit an RRC message, a MAC-CE, and/or DCI that maps the physical channel 731 across the symbol(s) 723 and the symbol(s) 729. The network may use a semi-persistent scheduling (SPS) (e.g., configured via RRC and activated via MAC-CE or DCI) or dynamic scheduling to indicate the TDRA for the physical channel 731.

In some aspects, as shown in FIG. 7, a time period between the symbol(s) 723 and the symbol(s) 729 may be null. As used herein, a “null” time period refers to a non-existent time gap. In other words, there may be no time gap between the symbol(s) 723 and the symbol(s) 729. Alternatively, the physical channel 731 may be mapped to one or more guard symbols (e.g., as described in connection with FIG. 8).

In some aspects, as further shown in FIG. 7, the symbol(s) 723 are associated with a same frequency resource allocation as the symbol(s) 729. For example, the network may indicate a same FDRA for a portion of the physical channel 731 mapped to the symbol(s) 723 as for a portion of the physical channel 731 mapped to the symbol(s) 729. Accordingly, in the example 700, a same narrow resource allocation used in the SBFD symbol(s) 723 is used in the non-SBFD symbol(s) 729.

In some aspects, the symbol(s) 723 are associated with a same TCI state as the symbol(s) 729. Accordingly, the UE 120 uses a same downlink beam when receiving in a portion of the physical channel 711 mapped to the symbol(s) 723 as in a portion of the physical channel 731 mapped to the symbol(s) 729.

A TCI state may indicate a directionality or a characteristic of the downlink beam, such as one or more quasi-co-location (QCL) properties of the downlink beam. As used herein, “quasi-co-location” or “QCL” refers to a situation in which properties of a channel over which a symbol on one port is conveyed can be inferred from a channel over which a symbol on the other antenna port is conveyed. A QCL property may include, for example, a Doppler shift, a Doppler spread, an average delay, a delay spread, or spatial receive parameters, among other examples. The TCI state may be indicated in a data structure (e.g., a TCI-State data structure, as defined in 3GPP specifications and/or another standard) of an RRC message.

By using techniques as described in connection with FIG. 7, the UE 120 may communicate on a physical channel that maps to a combination of full-duplex symbols and non-full-duplex symbols in a single slot. As a result, the UE 120 experiences increased throughput because the physical channel maps to additional symbols in the slot.

As indicated above, FIG. 7 is provided as an example. Other examples may differ from what is described with respect to FIG. 7.

FIG. 8 is a diagram illustrating an example 800 associated with a guard period in a slot with full-duplex symbols and non-full-duplex symbols, in accordance with the present disclosure. As shown in FIG. 8, example 800 includes an example slot configuration 801 and an example slot configuration 821.

The example slot configuration 801 is depicted for a single slot with one or more symbols 803 that are associated with SBFD. As shown in FIG. 8, the symbol(s) 803 include a first subband 805a associated with downlink, a second subband 805b also associated with downlink, and a third subband 807 associated with uplink. Other examples may include additional or fewer subbands associated with downlink and/or additional subbands associated with uplink. The example slot configuration 801 further includes one or more symbols 809 that are associated with non-SBFD. The symbol(s) 809 may be associated with uplink.

As further shown in FIG. 8, the example slot configuration 801 may include a time period 811 (e.g., including at least one symbol) between the symbol(s) 803 and the symbol(s) 809 that is a guard period. Communicating during the guard period is generally disallowed. In other words, a UE (e.g., UE 120) does not expect to transmit or receive during the guard period. Similarly, a network (e.g., via an RU 340 and/or a device controlling the RU 340, such as a DU 330 or a CU 310) refrains from transmitting or receiving during the guard period.

The guard period may be configured (e.g., via RRC signaling and/or according to 3GPP specifications) for all boundaries between full-duplex symbols and non-full-duplex symbols. Alternatively, the guard period may be conditional. For example, the time period 811 may be used as a guard period based on the full-duplex symbol(s) 803 preceding the uplink symbol(s) 809. As a result, the UE 120 may perform a timing adjustment and/or an RF retuning and adjustment during the guard period. In another example, a time period may be used as a guard period based on full-duplex symbols preceding dynamic symbols. As a result, the UE 120 may receive SFI that schedules the dynamic symbols before or during the guard period. On the other hand, no guard period may be used based on full-duplex symbols preceding downlink symbols. In another example, no guard period may be used based on full-duplex symbols preceding semi-static symbols.

Similarly, the example slot configuration 821 is depicted for a single slot with one or more symbols 823 that are associated with non-SBFD. The symbol(s) 823 may be associated with downlink. The example slot configuration 821 further includes one or more symbols 825 that are associated with SBFD. As shown in FIG. 8, the symbol(s) 825 include a first subband 827a associated with downlink, a second subband 827b also associated with downlink, and a third subband 829 associated with uplink. Other examples may include additional or fewer subbands associated with downlink and/or additional subbands associated with uplink.

As further shown in FIG. 8, the example slot configuration 821 may include a time period 831 (e.g., including at least one symbol) between the symbol(s) 823 and the symbol(s) 825 that is a guard period. Communicating during the guard period is generally disallowed. In other words, a UE (e.g., UE 120) does not expect to transmit or receive during the guard period. Similarly, a network (e.g., via an RU 340 and/or a device controlling the RU 340, such as a DU 330 or a CU 310) refrains from transmitting or receiving during the guard period.

As described in connection with the example slot configuration 801, the guard period may be configured (e.g., via RRC signaling and/or according to 3GPP specifications) for all boundaries between full-duplex symbols and non-full-duplex symbols. Alternatively, the guard period may be conditional. For example, the time period 831 may be used as a guard period based on the downlink symbol(s) 823 preceding the full-duplex symbol(s) 825. As a result, the UE 120 may perform a timing adjustment and/or an RF filter adjustment during the guard period. In another example, a time period may be used as a guard period based on dynamic symbols preceding full-duplex symbols. On the other hand, no guard period may be used based on full-duplex symbols preceding downlink symbols. In another example, no guard period may be used based on semi-status symbols preceding full-duplex symbols.

By using techniques as described in connection with FIG. 8, the UE 120 may perform timing adjustments, filter changes, beam changes, and/or other types of transmission or reception parameter adjustments during the guard period. As a result, the UE 120 experiences increased quality and reliability of communications and thus conserves power and processing resources that otherwise would have been wasted on failed decoding attempts and/or retransmissions.

As indicated above, FIG. 8 is provided as an example. Other examples may differ from what is described with respect to FIG. 8.

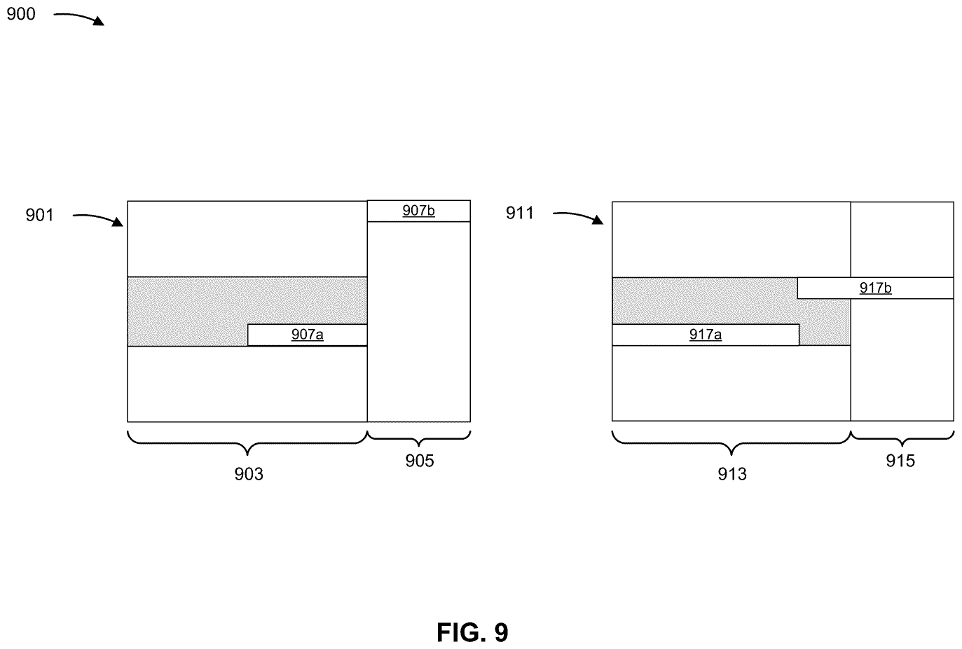

FIG. 9 is a diagram illustrating an example 900 associated with frequency hopping in a slot with full-duplex symbols and non-full-duplex symbols, in accordance with the present disclosure. As shown in FIG. 9, example 900 includes an example TDRA 901 and an example TDRA 911.

In some aspects, as described in connection with FIG. 7, a UE (e.g., UE 120) may transmit across a combination of SBFD symbols and non-SBFD symbols. The example TDRA 901 is depicted for a single slot with one or more symbols 903 that are associated with SBFD. The example TDRA 901 further includes one or more symbols 905 that are associated with non-SBFD. The symbol(s) 905 may be associated with uplink.

When the UE 120 is configured (e.g., via RRC signaling) for frequency hopping, the UE 120 may transmit for a first frequency hop 907a in only the symbol(s) 903. In another example, the UE 120 may transmit for a first frequency hop in only symbols associated with a non-full-duplex mode. Similarly, the UE 120 may transmit for a second frequency hop 907b in only the symbol(s) 905. In another example, the UE 120 may transmit for a second frequency hop in only symbols associated with a full-duplex mode. Therefore, each one of the frequency hops 907a and 907b is contained in a same symbol type (e.g., full-duplex type symbols or non-full-duplex type symbols).

Although the example 900 is shown without a guard period, other examples may include a guard period (e.g., as described in connection with FIG. 8). Accordingly, the UE 120 may refrain from transmitting for frequency hops 907a and 907b during the guard period. Alternatively, the UE 120 may transmit for the frequency hop 907a and/or the frequency hop 907b across the guard period.

Similarly, the example TDRA 911 is depicted for a single slot with one or more symbols 913 that are associated with SBFD. The example TDRA 911 further includes one or more symbols 915 that are associated with non-SBFD. The symbol(s) 915 may be associated with uplink.

When the UE 120 is configured (e.g., via RRC signaling) for frequency hopping, the UE 120 may transmit for a first frequency hop 917a in only the symbol(s) 903 and transmit for a second frequency hop 917b in a combination of the symbols(s) 903 and the symbol(s) 905. The second frequency hop 917b is associated with a same frequency resource allocation in the symbols(s) 903 and the symbol(s) 905. In another example, the UE 120 may transmit for a first frequency hop in a combination of symbols associated with the full-duplex mode and symbols associated with the non-full-duplex mode and may transmit for a second frequency hop in only symbols associated with the full-duplex mode or only symbols associated with the non-full-duplex mode.

Although the example 900 is shown without a guard period, other examples may include a guard period (e.g., as described in connection with FIG. 8). Accordingly, the UE 120 may refrain from transmitting for frequency hops 917a and 917b during the guard period. Alternatively, the UE 120 may transmit for the frequency hop 917a and/or the frequency hop 917b across the guard period.

Additionally, although described in connection with uplink, the example 900 may similarly apply to frequency hopping for downlink.

By using techniques as described in connection with FIG. 9, the UE 120 may communicate using frequency hopping across a combination of full-duplex symbols and non-full-duplex symbols in a single slot. As a result, the UE 120 experiences increased throughput because the UE 120 communicates across additional symbols in the slot.

As indicated above, FIG. 9 is provided as an example. Other examples may differ from what is described with respect to FIG. 9.

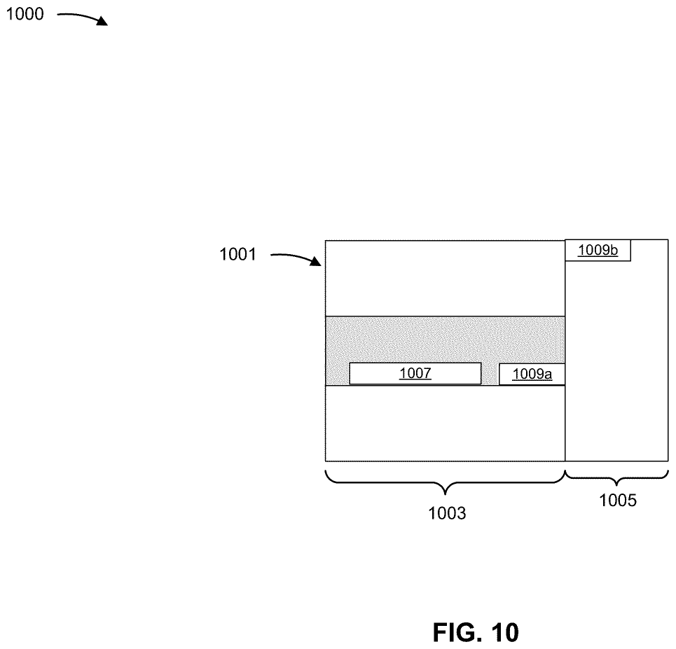

FIG. 10 is a diagram illustrating an example 1000 associated with PUSCH Type B repetition in a slot with full-duplex symbols and non-full-duplex symbols, in accordance with the present disclosure. As shown in FIG. 10, example 1000 includes an example TDRA 1001.

In some aspects, as described in connection with FIG. 7, a UE (e.g., UE 120) may transmit across a combination of SBFD symbols and non-SBFD symbols. The example TDRA 1001 is depicted for a single slot with one or more symbols 1003 that are associated with SBFD. The example TDRA 1001 further includes one or more symbols 1005 that are associated with non-SBFD. The symbol(s) 1005 may be associated with uplink.

The UE 120 may be configured (e.g., via RRC signaling) for Type B PUSCH repetition. According, the UE 120 may repeat a transmission using a nominal repetition that comprises a plurality of actual repetitions. For example, as shown in FIG. 10, a transmission 1007 may be repeated using actual repetition 1009a and actual repetition 1009b. As further shown in FIG. 10, the UE 120 may transmit the actual repetition 1009a in the symbol(s) 1003 and the actual repetition 1009b in the symbol(s) 1005. In another example, the UE 120 may transmit a first actual repetition in symbols associated with a non-full-duplex mode and a second actual repetition in symbols associated with a full-duplex mode.

Although the example 1000 is shown without a guard period, other examples may include a guard period (e.g., as described in connection with FIG. 8). Accordingly, the UE 120 may refrain from transmitting the actual repetitions 1009a and 1009b during the guard period. For example, a network (e.g., via an RU 340 and/or a device controlling the RU 340, such as a DU 330 or a CU 310) may indicate that the guard period is invalid (e.g., via RRC signaling) when the UE 120 is a legacy UE. Alternatively, the UE 120 may determine that the guard period is invalid when the UE 120 is capable of SBFD transmission (or at least is SBFD-aware). Alternatively, the UE 120 may transmit the actual repetition 1009a and/or the actual repetition 1009b across the guard period. In other words, a nominal PUSCH Type B repetition is split (or segmented) into two actual repetitions around a boundary between SBFD and non-SBFD symbols. Additionally, the guard period between SBFD and non-SBFD symbols, when present, may be considered as part of an invalid pattern for PUSCH repetition segmentation.

By using techniques as described in connection with FIG. 10, the UE 120 may perform Type B repetition across a combination of full-duplex symbols and non-full-duplex symbols in a single slot. As a result, the UE 120 experiences increased throughput because the UE 120 transmits across additional symbols in the slot.

As indicated above, FIG. 10 is provided as an example. Other examples may differ from what is described with respect to FIG. 10.

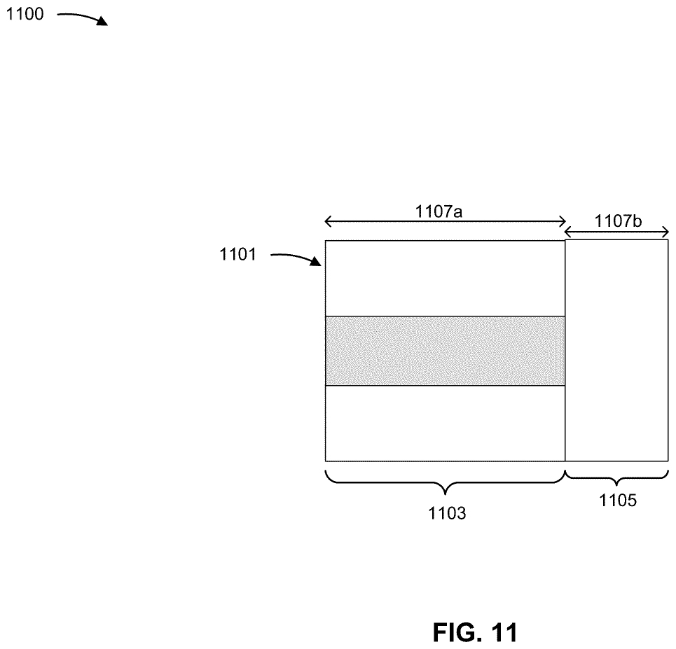

FIG. 11 is a diagram illustrating an example 1100 associated with a time domain window in a slot with full-duplex symbols and non-full-duplex symbols, in accordance with the present disclosure. As shown in FIG. 11, example 1100 includes an example slot configuration 1101.

The example slot configuration 1101 is depicted for a single slot with one or more symbols 1103 that are associated with SBFD. The example slot configuration 1101 further includes one or more symbols 1105 that are associated with non-SBFD.

A UE (e.g., UE 120) may be configured (e.g., via RRC signaling) for DMRS bundling. Accordingly, the UE 120 may calculate a measurement by aggregating received DMRSs across a nominal time domain window (TDW). As shown in FIG. 11, the UE 120 may aggregate DMRSs in a first nominal TDW 1107a that includes the symbol(s) 1103 and may separately aggregate DMRSs in a second nominal TDW 1107b that includes the symbol(s) 1105. In another example, the UE 120 may aggregate DMRSs in a first nominal TDW that includes symbols associated with a non-full-duplex mode and may separately aggregate DMRSs in a second nominal TDW that includes symbols associated with a full-duplex mode.

Although the example 1100 is shown without a guard period, other examples may include a guard period (e.g., as described in connection with FIG. 8). Accordingly, the UE 120 may exclude the guard period from the nominal TDW 1107a and/or the nominal TDW 1107b.

As indicated above, FIG. 11 is provided as an example. Other examples may differ from what is described with respect to FIG. 11.

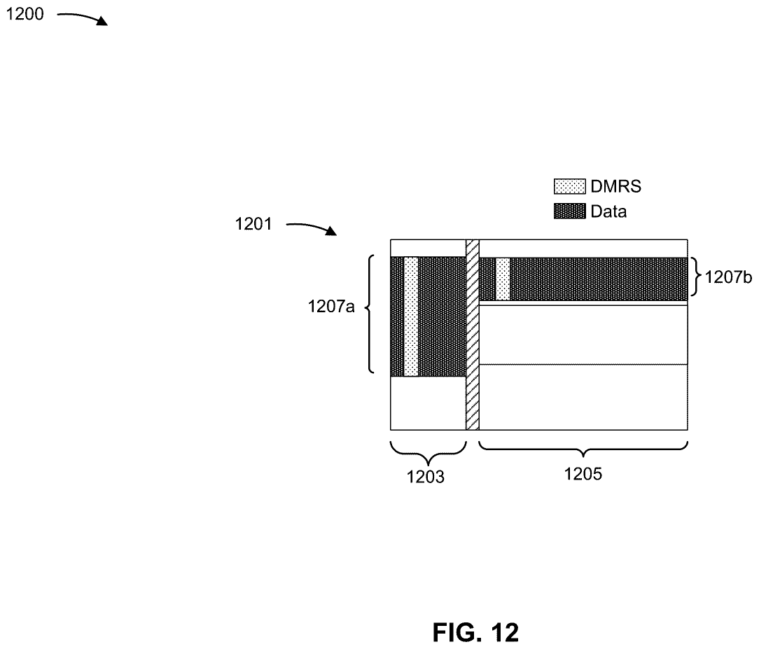

FIG. 12 is a diagram illustrating an example 1200 associated with an FDRA in a slot with full-duplex symbols and non-full-duplex symbols, in accordance with the present disclosure. As shown in FIG. 12, example 1200 includes an example TDRA 1201.

In some aspects, as described in connection with FIG. 7, a UE (e.g., UE 120) may transmit across a combination of SBFD symbols and non-SBFD symbols. The example TDRA 1201 is depicted for a single slot with one or more symbols 1203 that are associated with SBFD. The example TDRA 1201 further includes one or more symbols 1205 that are associated with non-SBFD. The symbol(s) 1205 may be associated with downlink.

As further shown in FIG. 12, a physical channel (e.g., a PDSCH in the example 1200 but, alternatively, a PDCCH) may be mapped to a wider frequency allocation 1207a in the symbol(s) 1203 and a narrower frequency allocation 1207b in the symbol(s) 1205. Accordingly, a network (e.g., via an RU 340 and/or a device controlling the RU 340, such as a DU 330 or a CU 310) may indicate multiple FDRAs for the physical channel (e.g., a first FDRA associated with the symbol(s) 1203 and a second FDRA associated with the symbol(s) 1205). Additionally, as shown in FIG. 12, the UE 120 may receive at least one first DMRS for the physical channel in the symbol(s) 1203 and at least one second DMRS for the physical channel in the symbol(s) 1205. Accordingly, the UE 120 may decode symbols on the physical channel even though the frequency allocations change.

Furthermore, the UE 120 may calculate a transport block size (TBS) based on a quantity of resource blocks (RBs) associated with full-duplex symbols and a quantity of RBs associated with non-full-duplex symbols. For example, the UE 120 may calculate a quantity of resource elements (REs) for the physical channel (e.g., represented by N_{RE}) according to N_{RE}=min(156, N_{RE}). n_{PRB}, where n_{PRB} represents a total quantity of allocated physical RBs (PRBs) for the UE 120 and may be equal to

$${n}_{P R B} = \frac{{n}_{P R {B}_{1}} \cdot {N}_{s y {m}_{1}} + {n}_{P R {B}_{2}} \cdot {N}_{s y m 2}}{{N}_{s y m 1} + {N}_{s y m 2}} ,$$

where n_{PRB}_{₁} represents the quantity of PRBs associated with the symbol(s) 1203, N_{sym}_{₁} represents a quantity of the symbol(s) 1203, n_{PRB}_{₂} represents the quantity of PRBs associated with the symbol(s) 1205, N_{sym}_{₂} represents a quantity of the symbol(s) 1205.

Although the example 1200 is shown with a guard period, other examples may exclude a guard period. Additionally, although described in connection with downlink, the example 1200 may similarly apply to FDRAs for uplink.

By using techniques as described in connection with FIG. 12, the UE 120 may communicate on a physical channel that maps to a combination of full-duplex symbols and non-full-duplex symbols in a single slot. As a result, the UE 120 experiences increased throughput because the physical channel maps to additional symbols in the slot.

As indicated above, FIG. 12 is provided as an example. Other examples may differ from what is described with respect to FIG. 12.

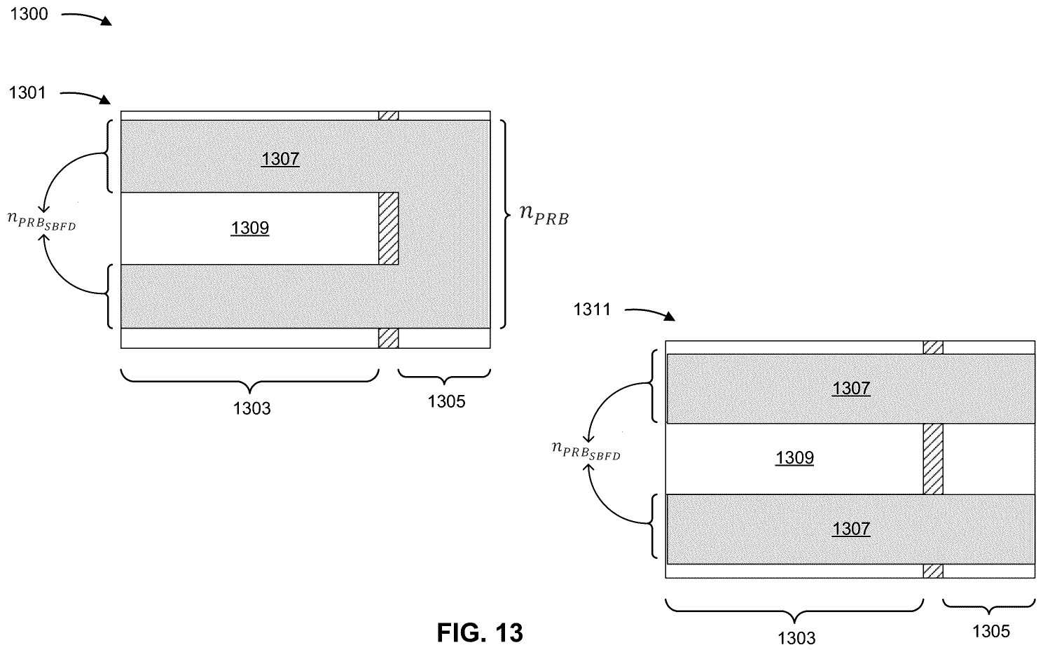

FIG. 13 is a diagram illustrating an example 1300 associated with an FDRA in a slot with full-duplex symbols and non-full-duplex symbols, in accordance with the present disclosure. As shown in FIG. 13, example 1300 includes an example TDRA 1301 and an example TDRA 1311.

In some aspects, as described in connection with FIG. 7, a UE (e.g., UE 120) may transmit across a combination of SBFD symbols and non-SBFD symbols. The example TDRAs 1301 and 1311 are depicted for a single slot with one or more symbols 1303 that are associated with SBFD. The example TDRAs 1301 and 1311 further include one or more symbols 1305 that are associated with non-SBFD. The symbol(s) 1305 may be associated with downlink.

In the example 1300, the UE 120 receives on a physical channel 1307 using rate-matching around an uplink subband 1309. As shown in the example TDRA 1301, the rate-matching may be applied across the symbol(s) 1303. Alternatively, as shown in the example TDRA 1311, the rate-matching may be applied across a combination of the symbol(s) 1303 and the symbol(s) 1305.

Furthermore, the UE 120 may calculate a TBS without considering the rate-matching. For example, the TBS may be calculated as N_{RE}=min(156, N_{RE}). n_{PRB}, where n_{PRB} represents a quantity of PRBs for the physical channel 1307 in the symbol(s) 1305. Alternatively, the UE 120 may calculate a TBS based on a quantity of RBs in the symbol(s) 1303. For example, the TBS may be calculated as N_{RE}=min(156, N_{RE}). n_{PRB}_{_{SBFD}}, where n_{PRB}_{_{SBFD}} represents a quantity of PRBs for the physical channel 1307 in the symbol(s) 1303. Alternatively, the UE 120 may calculate a TBS based on a combination of RBs in the symbol(s) 1303 and RBs in the symbol(s) 1305. For example, the TBS may be calculated as

$${N}_{R E} = min ( 156 , {N}_{R E} ) \cdot \frac{{n}_{P R {B}_{S B F D}} \cdot {N}_{{sym}_{SBFD}} + {n}_{P R B} \cdot {N}_{s y {m}_{non ‐ SBFD}}}{{N}_{s y {m}_{S B F D}} + {N}_{s y {m}_{n o n - S B F D}}} ,$$

where N_{sym}_{_{SBFD}} represents a quantity of symbols in the symbol(s) 1303, and N_{sym}_{_{non-SBFD}} represents a quantity of symbols in the symbol(s) 1305.

Although the example 1300 is shown with a guard period, other examples may exclude a guard period. Although the example 1300 is shown with the physical channel 1307 mapping to one or more symbols of the guard period, other examples may exclude the physical channel from mapping to the symbol(s) of the guard period.

By using techniques as described in connection with FIG. 13, the UE 120 may communicate on a physical channel 1307 that maps to a combination of full-duplex symbols and non-full-duplex symbols in a single slot. As a result, the UE 120 experiences increased throughput because the physical channel maps to additional symbols in the slot.

As indicated above, FIG. 13 is provided as an example. Other examples may differ from what is described with respect to FIG. 13.

FIG. 14 is a diagram illustrating an example process 1400 performed, for example, by a UE, in accordance with the present disclosure. Example process 1400 is an example where the UE (e.g., UE 120 and/or apparatus 1800 of FIG. 18) performs operations associated with physical channel mapping across full-duplex and non-full-duplex symbols.

As shown in FIG. 14, in some aspects, process 1400 may include receiving a time domain resource allocation associated with a physical channel that is mapped only to symbols associated with a full-duplex mode or only to symbols associated with a non-full-duplex mode in a slot (block 1410). For example, the UE (e.g., using reception component 1802 and/or communication manager 1806, depicted in FIG. 18) may receive a time domain resource allocation associated with a physical channel that is mapped only to symbols associated with a full-duplex mode or only to symbols associated with a non-full-duplex mode in a slot, as described herein.

As further shown in FIG. 14, in some aspects, process 1400 may include communicating with a network using the physical channel (block 1420). For example, the UE (e.g., using reception component 1802, transmission component 1804, and/or communication manager 1806, depicted in FIG. 18) may communicate with a network using the physical channel, as described herein.

Process 1400 may include additional aspects, such as any single aspect or any combination of aspects described below and/or in connection with one or more other processes described elsewhere herein.

In a first aspect, the full-duplex mode includes an SBFD mode.

In a second aspect, alone or in combination with the first aspect, communicating with the network includes receiving a communication from the network over the physical channel.

In a third aspect, alone or in combination with one or more of the first and second aspects, the physical channel includes a PDSCH or a PDCCH.

In a fourth aspect, alone or in combination with one or more of the first through third aspects, communicating with the network includes transmitting a communication to the network over the physical channel.

In a fifth aspect, alone or in combination with one or more of the first through fourth aspects, the physical channel includes a PUCCH or a PUSCH.

In a sixth aspect, alone or in combination with one or more of the first through fifth aspects, process 1400 includes receiving (e.g., using reception component 1802 and/or communication manager 1806) an additional time domain allocation, associated with an additional physical channel that is mapped to a combination of symbols associated with the full-duplex mode and symbols associated with the non-full-duplex mode, and discarding (e.g., using communication manager 1806) the additional time domain allocation.

In a seventh aspect, alone or in combination with one or more of the first through sixth aspects, a time period, between the symbols associated with the full-duplex mode and the symbols associated with the non-full-duplex mode, is a guard period.

In an eighth aspect, alone or in combination with one or more of the first through seventh aspects, the guard period includes at least one flexible symbol.

In a ninth aspect, alone or in combination with one or more of the first through eighth aspects, the time period is the guard period based at least in part on the symbols associated with the full-duplex mode preceding symbols associated with non-full-duplex uplink.

In a tenth aspect, alone or in combination with one or more of the first through ninth aspects, the time period is the guard period based at least in part on the symbols associated with the full-duplex mode following symbols associated with non-full-duplex downlink.

In an eleventh aspect, alone or in combination with one or more of the first through tenth aspects, the time period is the guard period based at least in part on the symbols associated with the full-duplex mode preceding or following dynamic symbols.

In a twelfth aspect, alone or in combination with one or more of the first through eleventh aspects, process 1400 includes dropping a communication (e.g., using reception component 1802, transmission component 1804, and/or communication manager 1806) scheduled during the guard period.

In a thirteenth aspect, alone or in combination with one or more of the first through twelfth aspects, a time period, between the symbols associated with the full-duplex mode and the symbols associated with the non-full-duplex mode, is null.

In a fourteenth aspect, alone or in combination with one or more of the first through thirteenth aspects, a first actual TDW, associated with DMRS bundling, includes the symbols associated with the full-duplex mode and a second actual TDW includes the symbols associated with the non-full-duplex mode.

In a fifteenth aspect, alone or in combination with one or more of the first through fourteenth aspects, communicating with the network includes dropping a communication scheduled across a combination of at least one of the symbols associated with the full-duplex mode and at least one of the symbols associated with the non-full-duplex mode.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a network node, in accordance with the present disclosure. Example process 1500 is an example where the network node (e.g., network node 110 and/or apparatus 1900 of FIG. 19) performs operations associated with physical channel mapping across full-duplex and non-full-duplex symbols.

As shown in FIG. 15, in some aspects, process 1500 may include transmitting a time domain resource allocation associated with a physical channel that is mapped only to symbols associated with a full-duplex mode or only to symbols associated with a non-full-duplex mode in a slot (block 1510). For example, the network node (e.g., using transmission component 1904 and/or communication manager 1906, depicted in FIG. 19) may transmit a time domain resource allocation associated with a physical channel that is mapped only to symbols associated with a full-duplex mode or only to symbols associated with a non-full-duplex mode in a slot, as described herein.

As further shown in FIG. 15, in some aspects, process 1500 may include communicating with a UE using the physical channel (block 1520). For example, the network node (e.g., using reception component 1902, transmission component 1904, and/or communication manager 1906, depicted in FIG. 19) may communicate with a UE using the physical channel, as described herein.

Process 1500 may include additional aspects, such as any single aspect or any combination of aspects described below and/or in connection with one or more other processes described elsewhere herein.

In a first aspect, the full-duplex mode comprises an SBFD mode.

In a second aspect, alone or in combination with the first aspect, communicating with the UE includes transmitting a communication to the UE over the physical channel.

In a third aspect, alone or in combination with one or more of the first and second aspects, the physical channel includes a PDSCH or a PDCCH.

In a fourth aspect, alone or in combination with one or more of the first through third aspects, communicating with the UE includes receiving a communication from the UE over the physical channel.

In a fifth aspect, alone or in combination with one or more of the first through fourth aspects, the physical channel includes a PUCCH or a PUSCH.

In a sixth aspect, alone or in combination with one or more of the first through fifth aspects, a time period, between the symbols associated with the full-duplex mode and the symbols associated with the non-full-duplex mode, is a guard period.

In a seventh aspect, alone or in combination with one or more of the first through sixth aspects, the guard period includes at least one flexible symbol.

In an eighth aspect, alone or in combination with one or more of the first through seventh aspects, the time period is the guard period based at least in part on the symbols associated with the full-duplex mode preceding symbols associated with non-full-duplex uplink.

In a ninth aspect, alone or in combination with one or more of the first through eighth aspects, the time period is the guard period based at least in part on the symbols associated with the full-duplex mode following symbols associated with non-full-duplex downlink.

In a tenth aspect, alone or in combination with one or more of the first through ninth aspects, the time period is the guard period based at least in part on the symbols associated with the full-duplex mode preceding or following dynamic symbols.

In an eleventh aspect, alone or in combination with one or more of the first through tenth aspects, process 1500 includes refraining from communicating (e.g., using reception component 1902, transmission component 1904, and/or communication manager 1906) with the UE during the guard period.

In a twelfth aspect, alone or in combination with one or more of the first through eleventh aspects, a time period, between the symbols associated with the full-duplex mode and the symbols associated with the non-full-duplex mode, is null.

In a thirteenth aspect, alone or in combination with one or more of the first through twelfth aspects, a first actual TDW, associated with DMRS bundling, includes the symbols associated with the full-duplex mode and a second actual TDW includes the symbols associated with the non-full-duplex mode.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, by a UE, in accordance with the present disclosure. Example process 1600 is an example where the UE (e.g., UE 120 and/or apparatus 1800 of FIG. 18) performs operations associated with physical channel mapping across full-duplex and non-full-duplex symbols.

As shown in FIG. 16, in some aspects, process 1600 may include receiving a time domain resource allocation associated with a physical channel that is mapped to a combination of symbols associated with a full-duplex mode and symbols associated with a non-full-duplex mode in a slot (block 1610). For example, the UE (e.g., using reception component 1802 and/or communication manager 1806, depicted in FIG. 18) may receive a time domain resource allocation associated with a physical channel that is mapped to a combination of symbols associated with a full-duplex mode and symbols associated with a non-full-duplex mode in a slot, as described herein.

As further shown in FIG. 16, in some aspects, process 1600 may include communicating with a network using the physical channel (block 1620). For example, the UE (e.g., using reception component 1802, transmission component 1804, and/or communication manager 1806, depicted in FIG. 18) may communicate with a network using the physical channel, as described herein.

Process 1600 may include additional aspects, such as any single aspect or any combination of aspects described below and/or in connection with one or more other processes described elsewhere herein.

In a first aspect, the full-duplex mode includes an SBFD mode.

In a second aspect, alone or in combination with the first aspect, communicating with the network includes receiving a communication from the network over the physical channel.

In a third aspect, alone or in combination with one or more of the first and second aspects, the physical channel includes a PDSCH or a PDCCH.

In a fourth aspect, alone or in combination with one or more of the first through third aspects, communicating with the network includes transmitting a communication to the network over the physical channel.

In a fifth aspect, alone or in combination with one or more of the first through fourth aspects, the physical channel includes a PUCCH or a PUSCH.

In a sixth aspect, alone or in combination with one or more of the first through fifth aspects, a time period, between the symbols associated with the full-duplex mode and the symbols associated with the non-full-duplex mode, is null.

In a seventh aspect, alone or in combination with one or more of the first through sixth aspects, the symbols associated with the full-duplex mode are associated with a same frequency resource allocation as the symbols associated with the non-full-duplex mode.

In an eighth aspect, alone or in combination with one or more of the first through seventh aspects, the symbols associated with the full-duplex mode are associated with same spatial relation information as the symbols associated with the non-full-duplex mode.

In a ninth aspect, alone or in combination with one or more of the first through eighth aspects, the symbols associated with the full-duplex mode are associated with a same TCI as the symbols associated with the non-full-duplex mode.

In a tenth aspect, alone or in combination with one or more of the first through ninth aspects, communicating with the network includes transmitting or receiving, for a first frequency hop, in only the symbols associated with the full-duplex mode or only the symbols associated with the non-full-duplex mode, and transmitting or receiving, for a second frequency hop, in only the symbols associated with the full-duplex mode or only the symbols associated with the non-full-duplex mode.

In an eleventh aspect, alone or in combination with one or more of the first through tenth aspects, communicating with the network includes transmitting or receiving, for a frequency hop, in the combination of the symbols associated with the full-duplex mode and the symbols associated with the non-full-duplex mode, on a same frequency resource allocation.

In a twelfth aspect, alone or in combination with one or more of the first through eleventh aspects, communicating with the network includes transmitting a nominal repetition using a first actual repetition in the symbols associated with the full-duplex mode and a second actual repetition in the symbols associated with the non-full-duplex mode.

In a thirteenth aspect, alone or in combination with one or more of the first through twelfth aspects, a first actual TDW, associated with DMRS bundling, includes the symbols associated with the full-duplex mode, and a second actual TDW includes the symbols associated with the non-full-duplex mode.

In a fourteenth aspect, alone or in combination with one or more of the first through thirteenth aspects, communicating with the network includes receiving at least one first DMRS in the symbols associated with the full-duplex mode, and receiving at least one second DMRS in the symbols associated with the non-full-duplex mode.

In a fifteenth aspect, alone or in combination with one or more of the first through fourteenth aspects, a TBS, associated with communicating with the network, is calculated using a first quantity of PRBs associated with the symbols associated with the full-duplex mode and a second quantity of PRBs associated with the symbols associated with the non-full-duplex mode.

In a sixteenth aspect, alone or in combination with one or more of the first through fifteenth aspects, process 1600 includes receiving (e.g., using reception component 1802 and/or communication manager 1806) a first FDRA associated with the symbols that are associated with the full-duplex mode and a second FDRA associated with the symbols that are associated with the non-full-duplex mode.

In a seventeenth aspect, alone or in combination with one or more of the first through sixteenth aspects, communicating with the network includes receiving from the network using rate-matching around an uplink subband in the symbols associated with the non-full-duplex mode.

In an eighteenth aspect, alone or in combination with one or more of the first through seventeenth aspects, the rate-matching is applied across the symbols associated with the full-duplex mode.

In a nineteenth aspect, alone or in combination with one or more of the first through eighteenth aspects, the rate-matching is applied across the combination of the symbols associated with the full-duplex mode and the symbols associated with the non-full-duplex mode.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, by a network node, in accordance with the present disclosure. Example process 1700 is an example where the network node (e.g., network node 110 and/or apparatus 1900 of FIG. 19) performs operations associated with physical channel mapping across full-duplex and non-full-duplex symbols.

As shown in FIG. 17, in some aspects, process 1700 may include transmitting a time domain resource allocation associated with a physical channel that is mapped to a combination of symbols associated with a full-duplex mode and symbols associated with a non-full-duplex mode in a slot (block 1710). For example, the network node (e.g., using transmission component 1904 and/or communication manager 1906, depicted in FIG. 19) may transmit a time domain resource allocation associated with a physical channel that is mapped to a combination of symbols associated with a full-duplex mode and symbols associated with a non-full-duplex mode in a slot, as described herein.

As further shown in FIG. 17, in some aspects, process 1700 may include communicating with a UE using the physical channel (block 1720). For example, the network node (e.g., using reception component 1902, transmission component 1904, and/or communication manager 1906, depicted in FIG. 19) may communicate with a UE using the physical channel, as described herein.

Process 1700 may include additional aspects, such as any single aspect or any combination of aspects described below and/or in connection with one or more other processes described elsewhere herein.

In a first aspect, the full-duplex mode includes an SBFD mode.

In a second aspect, alone or in combination with the first aspect, communicating with the UE includes transmitting a communication to the UE over the physical channel.

In a third aspect, alone or in combination with one or more of the first and second aspects, the physical channel includes a PDSCH or a PDCCH.

In a fourth aspect, alone or in combination with one or more of the first through third aspects, communicating with the UE includes receiving a communication from the UE over the physical channel.

In a fifth aspect, alone or in combination with one or more of the first through fourth aspects, the physical channel includes a PUCCH or a PUSCH.

In a sixth aspect, alone or in combination with one or more of the first through fifth aspects, a time period, between the symbols associated with the full-duplex mode and the symbols associated with the non-full-duplex mode, is null.

In a seventh aspect, alone or in combination with one or more of the first through sixth aspects, the symbols associated with the full-duplex mode are associated with a same frequency resource allocation as the symbols associated with the non-full-duplex mode.

In an eighth aspect, alone or in combination with one or more of the first through seventh aspects, the symbols associated with the full-duplex mode are associated with same spatial relation information as the symbols associated with the non-full-duplex mode.

In a ninth aspect, alone or in combination with one or more of the first through eighth aspects, the symbols associated with the full-duplex mode are associated with a same TCI as the symbols associated with the non-full-duplex mode.

In a tenth aspect, alone or in combination with one or more of the first through ninth aspects, communicating with the UE includes transmitting or receiving, for a first frequency hop, in only the symbols associated with the full-duplex mode or only the symbols associated with the non-full-duplex mode, and transmitting or receiving, for a second frequency hop, in only the symbols associated with the full-duplex mode or only the symbols associated with the non-full-duplex mode.

In an eleventh aspect, alone or in combination with one or more of the first through tenth aspects, communicating with the UE includes transmitting or receiving, for a frequency hop, in the combination of the symbols associated with the full-duplex mode and the symbols associated with the non-full-duplex mode, on a same frequency resource allocation.

In a twelfth aspect, alone or in combination with one or more of the first through eleventh aspects, communicating with the UE includes receiving a nominal repetition using a first actual repetition in the symbols associated with the full-duplex mode and a second actual repetition in the symbols associated with the non-full-duplex mode.

In a thirteenth aspect, alone or in combination with one or more of the first through twelfth aspects, a first actual TDW, associated with DMRS bundling, includes the symbols associated with the full-duplex mode, and a second actual TDW includes the symbols associated with the non-full-duplex mode.

In a fourteenth aspect, alone or in combination with one or more of the first through thirteenth aspects, communicating with the UE includes transmitting at least one first DMRS in the symbols associated with the full-duplex mode, and transmitting at least one second DMRS in the symbols associated with the non-full-duplex mode.

In a fifteenth aspect, alone or in combination with one or more of the first through fourteenth aspects, a TBS, associated with communicating with the UE, is calculated using a first quantity of PRBs associated with the symbols associated with the full-duplex mode and a second quantity of PRBs associated with the symbols associated with the non-full-duplex mode.

In a sixteenth aspect, alone or in combination with one or more of the first through fifteenth aspects, process 1700 includes transmitting (e.g., using transmission component 1904 and/or communication manager 1906) a first FDRA associated with the symbols that are associated with the full-duplex mode and a second FDRA associated with the symbols that are associated with the non-full-duplex mode.

In a seventeenth aspect, alone or in combination with one or more of the first through sixteenth aspects, communicating with the UE includes transmitting using rate-matching around an uplink subband in the symbols associated with the non-full-duplex mode.

In an eighteenth aspect, alone or in combination with one or more of the first through seventeenth aspects, the rate-matching is applied across the symbols associated with the full-duplex mode.

In a nineteenth aspect, alone or in combination with one or more of the first through eighteenth aspects, the rate-matching is applied across the combination of the symbols associated with the full-duplex mode and the symbols associated with the non-full-duplex mode.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram of an example apparatus 1800 for wireless communication, in accordance with the present disclosure. The apparatus 1800 may be a UE, or a UE may include the apparatus 1800. In some aspects, the apparatus 1800 includes a reception component 1802, a transmission component 1804, and/or a communication manager 1806, which may be in communication with one another (for example, via one or more buses and/or one or more other components). In some aspects, the communication manager 1806 is the communication manager 140 described in connection with FIG. 1. As shown, the apparatus 1800 may communicate with another apparatus 1808, such as a UE or a network node (such as a CU, a DU, an RU, or a base station), using the reception component 1802 and the transmission component 1804.

In some aspects, the apparatus 1800 may be configured to perform one or more operations described herein in connection with FIGS. 6-13. Additionally, or alternatively, the apparatus 1800 may be configured to perform one or more processes described herein, such as process 1400 of FIG. 14, process 1600 of FIG. 16, or a combination thereof. In some aspects, the apparatus 1800 and/or one or more components shown in FIG. 18 may include one or more components of the UE described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1802 may receive communications, such as reference signals, control information, data communications, or a combination thereof, from the apparatus 1808. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, a modem, a demodulator, a MIMO detector, a receive processor, a controller/processor, a memory, or a combination thereof, of the UE described in connection with FIG. 2.

The transmission component 1804 may transmit communications, such as reference signals, control information, data communications, or a combination thereof, to the apparatus 1808. In some aspects, one or more other components of the apparatus 1800 may generate communications and may provide the generated communications to the transmission component 1804 for transmission to the apparatus 1808. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1808. In some aspects, the transmission component 1804 may include one or more antennas, a modem, a modulator, a transmit MIMO processor, a transmit processor, a controller/processor, a memory, or a combination thereof, of the UE described in connection with FIG. 2. In some aspects, the transmission component 1804 may be co-located with the reception component 1802 in a transceiver.

The communication manager 1806 may support operations of the reception component 1802 and/or the transmission component 1804. For example, the communication manager 1806 may receive information associated with configuring reception of communications by the reception component 1802 and/or transmission of communications by the transmission component 1804. Additionally, or alternatively, the communication manager 1806 may generate and/or provide control information to the reception component 1802 and/or the transmission component 1804 to control reception and/or transmission of communications.

In some aspects, the reception component 1802 may receive (e.g., from the apparatus 1808) a TDRA associated with a physical channel that is mapped only to symbols associated with a full-duplex mode or only to symbols associated with a non-full-duplex mode in a slot. Accordingly, the reception component 1802 and/or the transmission component 1804 may communicate (e.g., with the apparatus 1808) using the physical channel. Additionally, the reception component 1802 may receive an additional TDRA associated with an additional physical channel that is mapped to a combination of symbols associated with the full-duplex mode and symbols associated with the non-full-duplex mode, and the communication manager 1806 may discard the additional TDRA.

Alternatively, the reception component 1802 may (e.g., from the apparatus 1808) a TDRA associated with a physical channel that is mapped to a combination of symbols associated with a full-duplex mode and symbols associated with a non-full-duplex mode in a slot. Accordingly, the reception component 1802 and/or the transmission component 1804 may communicate (e.g., with the apparatus 1808) using the physical channel. Additionally, the reception component 1802 may receive a first FDRA associated with the symbols that are associated with the full-duplex mode and a second FDRA associated with the symbols that are associated with the non-full-duplex mode.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

FIG. 19 is a diagram of an example apparatus 1900 for wireless communication, in accordance with the present disclosure. The apparatus 1900 may be a network node, or a network node may include the apparatus 1900. In some aspects, the apparatus 1900 includes a reception component 1902, a transmission component 1904, and/or a communication manager 1906, which may be in communication with one another (for example, via one or more buses and/or one or more other components). In some aspects, the communication manager 1906 is the communication manager 150 described in connection with FIG. 1. As shown, the apparatus 1900 may communicate with another apparatus 1908, such as a UE or a network node (such as a CU, a DU, an RU, or a base station), using the reception component 1902 and the transmission component 1904.

In some aspects, the apparatus 1900 may be configured to perform one or more operations described herein in connection with FIGS. 6-13. Additionally, or alternatively, the apparatus 1900 may be configured to perform one or more processes described herein, such as process 1500 of FIG. 15, process 1700 of FIG. 17, or a combination thereof. In some aspects, the apparatus 1900 and/or one or more components shown in FIG. 19 may include one or more components of the network node described in connection with FIG. 2. Additionally, or alternatively, one or more components shown in FIG. 19 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1902 may receive communications, such as reference signals, control information, data communications, or a combination thereof, from the apparatus 1908. The reception component 1902 may provide received communications to one or more other components of the apparatus 1900. In some aspects, the reception component 1902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1900. In some aspects, the reception component 1902 may include one or more antennas, a modem, a demodulator, a MIMO detector, a receive processor, a controller/processor, a memory, or a combination thereof, of the network node described in connection with FIG. 2. In some aspects, the reception component 1902 and/or the transmission component 1904 may include or may be included in a network interface. The network interface may be configured to obtain and/or output signals for the apparatus 1900 via one or more communications links, such as a backhaul link, a midhaul link, and/or a fronthaul link.

The transmission component 1904 may transmit communications, such as reference signals, control information, data communications, or a combination thereof, to the apparatus 1908. In some aspects, one or more other components of the apparatus 1900 may generate communications and may provide the generated communications to the transmission component 1904 for transmission to the apparatus 1908. In some aspects, the transmission component 1904 may perform signal processing on the generated communications (such as filtering, amplification, modulation, digital-to-analog conversion, multiplexing, interleaving, mapping, or encoding, among other examples), and may transmit the processed signals to the apparatus 1908. In some aspects, the transmission component 1904 may include one or more antennas, a modem, a modulator, a transmit MIMO processor, a transmit processor, a controller/processor, a memory, or a combination thereof, of the network node described in connection with FIG. 2. In some aspects, the transmission component 1904 may be co-located with the reception component 1902 in a transceiver.

The communication manager 1906 may support operations of the reception component 1902 and/or the transmission component 1904. For example, the communication manager 1906 may receive information associated with configuring reception of communications by the reception component 1902 and/or transmission of communications by the transmission component 1904. Additionally, or alternatively, the communication manager 1906 may generate and/or provide control information to the reception component 1902 and/or the transmission component 1904 to control reception and/or transmission of communications.

In some aspects, the transmission component 1904 may transmit (e.g., to the apparatus 1908) a TDRA associated with a physical channel that is mapped only to symbols associated with a full-duplex mode or only to symbols associated with a non-full-duplex mode in a slot. Accordingly, the reception component 1902 and/or the transmission component 1904 may communicate (e.g., with the apparatus 1908) using the physical channel.

Additionally, or alternatively, the transmission component 1904 may transmit (e.g., to the apparatus 1908) a TDRA associated with a physical channel that is mapped to a combination of symbols associated with a full-duplex mode and symbols associated with a non-full-duplex mode in a slot. Accordingly, the reception component 1902 and/or the transmission component 1904 may communicate (e.g., with the apparatus 1908) using the physical channel. Additionally, the transmission component 1904 may transmit a first FDRA associated with the symbols that are associated with the full-duplex mode and a second FDRA associated with the symbols that are associated with the non-full-duplex mode.

The number and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally, or alternatively, a set of (one or more) components shown in FIG. 19 may perform one or more functions described as being performed by another set of components shown in FIG. 19.

The following provides an overview of some Aspects of the present disclosure:

Aspect 1: A method of wireless communication performed by a user equipment (UE), comprising: receiving, from a network, a time domain resource allocation associated with a physical channel that is mapped only to symbols associated with a full-duplex mode or only to symbols associated with a non-full-duplex mode in a slot; and communicating with the network using the physical channel.

Aspect 2: The method of Aspect 1, wherein the full-duplex mode comprises a subband full duplex mode.

Aspect 3: The method of any of Aspects 1-2, wherein communicating with the network comprises: receiving a communication from the network over the physical channel.

Aspect 4: The method of Aspect 3, wherein the physical channel comprises a physical downlink shared channel or a physical downlink control channel.

Aspect 5: The method of any of Aspects 1-2, wherein communicating with the network comprises: transmitting a communication to the network over the physical channel.

Aspect 6: The method of Aspect 5, wherein the physical channel comprises a physical uplink control channel or a physical uplink shared channel.

Aspect 7: The method of any of Aspects 1-6, wherein communicating with the network comprises: dropping a communication scheduled across a combination of at least one of the symbols associated with the full-duplex mode and at least one of the symbols associated with the non-full-duplex mode.

Aspect 8: The method of any of Aspects 1-7, further comprising: receiving an additional time domain allocation associated with an additional physical channel that is mapped to a combination of symbols associated with the full-duplex mode and symbols associated with the non-full-duplex mode; and discarding the additional time domain allocation.

Aspect 9: The method of any of Aspects 1-8, wherein a time period, between the symbols associated with the full-duplex mode and the symbols associated with the non-full-duplex mode, is a guard period.

Aspect 10: The method of Aspect 9, wherein the guard period includes at least one flexible symbol.

Aspect 11: The method of any of Aspects 9-10, wherein the time period is the guard period based at least in part on the symbols associated with the full-duplex mode preceding symbols associated with non-full-duplex uplink.

Aspect 12: The method of any of Aspects 9-10, wherein the time period is the guard period based at least in part on the symbols associated with the full-duplex mode following symbols associated with non-full-duplex downlink.

Aspect 13: The method of any of Aspects 9-10, wherein the time period is the guard period based at least in part on the symbols associated with the full-duplex mode preceding or following dynamic symbols.

Aspect 14: The method of any of Aspects 9-13, further comprising: drop a communication scheduled during the guard period.

Aspect 15: The method of any of Aspects 1-8, wherein a time period, between the symbols associated with the full-duplex mode and the symbols associated with the non-full-duplex mode, is null.

Aspect 16: The method of any of Aspects 1-15, wherein a first actual time domain window, associated with demodulation reference signal bundling, includes the symbols associated with the full-duplex mode and a second actual time domain window includes the symbols associated with the non-full-duplex mode.

Aspect 17: A method of wireless communication performed by a network node, comprising: transmitting a time domain resource allocation associated with a physical channel that is mapped only to symbols associated with a full-duplex mode or only to symbols associated with a non-full-duplex mode in a slot; and communicating with a user equipment (UE) using the physical channel.

Aspect 18: The method of Aspect 17, wherein the full-duplex mode comprises a subband full duplex mode.

Aspect 19: The method of any of Aspects 17-18, wherein communicating with the UE comprises: transmitting a communication to the UE over the physical channel.

Aspect 20: The method of Aspect 19, wherein the physical channel comprises a physical downlink shared channel or a physical downlink control channel.

Aspect 21: The method of any of Aspects 17-18, wherein communicating with the UE comprises: receiving a communication from the UE over the physical channel.

Aspect 22: The method of Aspect 21, wherein the physical channel comprises a physical uplink control channel or a physical uplink shared channel.

Aspect 23: The method of any of Aspects 17-22, wherein a time period, between the symbols associated with the full-duplex mode and the symbols associated with the non-full-duplex mode, is a guard period.

Aspect 24: The method of Aspect 23, wherein the guard period includes at least one flexible symbol.

Aspect 25: The method of any of Aspects 23-24, wherein the time period is the guard period based at least in part on the symbols associated with the full-duplex mode preceding symbols associated with non-full-duplex uplink.

Aspect 26: The method of any of Aspects 23-24, wherein the time period is the guard period based at least in part on the symbols associated with the full-duplex mode following symbols associated with non-full-duplex downlink.

Aspect 27: The method of any of Aspects 23-24, wherein the time period is the guard period based at least in part on the symbols associated with the full-duplex mode preceding or following dynamic symbols.

Aspect 28: The method of any of Aspects 23-27, further comprising: refraining from communicating with the UE during the guard period.

Aspect 29: The method of any of Aspects 17-22, wherein a time period, between the symbols associated with the full-duplex mode and the symbols associated with the non-full-duplex mode, is null.

Aspect 30: The method of any of Aspects 17-29, wherein a first actual time domain window, associated with demodulation reference signal bundling, includes the symbols associated with the full-duplex mode and a second actual time domain window includes the symbols associated with the non-full-duplex mode.

Aspect 31: A method of wireless communication performed by a user equipment (UE), comprising: receiving, from a network, a time domain resource allocation associated with a physical channel that is mapped to a combination of symbols associated with a full-duplex mode and symbols associated with a non-full-duplex mode in a slot; and communicating with the network using the physical channel.

Aspect 32: The method of Aspect 31, wherein the full-duplex mode comprises a subband full duplex mode.

Aspect 33: The method of any of Aspects 31-32, wherein communicating with the network comprises: receiving a communication from the network over the physical channel.

Aspect 34: The method of Aspect 33, wherein the physical channel comprises a physical downlink shared channel or a physical downlink control channel.

Aspect 35: The method of any of Aspects 31-32, wherein communicating with the network comprises: transmitting a communication to the network over the physical channel.

Aspect 36: The method of Aspect 35, wherein the physical channel comprises a physical uplink control channel or a physical uplink shared channel.

Aspect 37: The method of any of Aspects 31-36, wherein a time period, between the symbols associated with the full-duplex mode and the symbols associated with the non-full-duplex mode, is null.

Aspect 38: The method of any of Aspects 31-37, wherein the symbols associated with the full-duplex mode are associated with a same frequency resource allocation as the symbols associated with the non-full-duplex mode.

Aspect 39: The method of any of Aspects 31-38, wherein the symbols associated with the full-duplex mode are associated with same spatial relation information as the symbols associated with the non-full-duplex mode.

Aspect 40: The method of any of Aspects 31-38, wherein the symbols associated with the full-duplex mode are associated with a same transmission configuration indicator as the symbols associated with the non-full-duplex mode.

Aspect 41: The method of any of Aspects 31-40, wherein communicating with the network comprises: transmitting or receiving, for a first frequency hop, in only the symbols associated with the full-duplex mode or only the symbols associated with the non-full-duplex mode; and transmitting or receiving, for a second frequency hop, in only the symbols associated with the full-duplex mode or only the symbols associated with the non-full-duplex mode.

Aspect 42: The method of any of Aspects 31-40, wherein communicating with the network comprises: transmitting or receiving, for a frequency hop, in the combination of the symbols associated with the full-duplex mode and the symbols associated with the non-full-duplex mode, on a same frequency resource allocation.

Aspect 43: The method of any of Aspects 31-42, wherein communicating with the network comprises: transmitting a nominal repetition using a first actual repetition in the symbols associated with the full-duplex mode and a second actual repetition in the symbols associated with the non-full-duplex mode.

Aspect 44: The method of any of Aspects 31-43, wherein a first actual time domain window, associated with demodulation reference signal bundling, includes the symbols associated with the full-duplex mode, and a second actual time domain window includes the symbols associated with the non-full-duplex mode.

Aspect 45: The method of any of Aspects 31-44, wherein communicating with the network comprises: receiving at least one first demodulation reference signal (DMRS) in the symbols associated with the full-duplex mode; and receiving at least one second DMRS in the symbols associated with the non-full-duplex mode.

Aspect 46: The method of any of Aspects 31-45, wherein a transport block size, associated with communicating with the network, is calculated using a first quantity of physical resource blocks (PRBs) associated with the symbols associated with the full-duplex mode and a second quantity of PRBs associated with the symbols associated with the non-full-duplex mode.

Aspect 47: The method of any of Aspects 31-46, further comprising: receiving a first frequency domain resource allocation associated with the symbols that are associated with the full-duplex mode and a second frequency domain resource allocation associated with the symbols that are associated with the non-full-duplex mode.

Aspect 48: The method of any of Aspects 31-47, wherein communicating with the network comprises: receiving from the network using rate-matching around an uplink subband in the symbols associated with the non-full-duplex mode.

Aspect 49: The method of Aspect 48, wherein the rate-matching is applied across the symbols associated with the full-duplex mode.

Aspect 50: The method of Aspect 48, where the rate-matching is applied across the combination of the symbols associated with the full-duplex mode and the symbols associated with the non-full-duplex mode.

Aspect 51: A method of wireless communication performed by a network node, comprising: transmitting a time domain resource allocation associated with a physical channel that is mapped to a combination of symbols associated with a full-duplex mode and symbols associated with a non-full-duplex mode in a slot; and communicating with a user equipment (UE) using the physical channel.

Aspect 52: The method of Aspect 51, wherein the full-duplex mode comprises a subband full duplex mode.

Aspect 53: The method of any of Aspects 51-52, wherein communicating with the UE comprises: transmitting a communication to the UE over the physical channel.

Aspect 54: The method of Aspect 53, wherein the physical channel comprises a physical downlink shared channel or a physical downlink control channel.

Aspect 55: The method of any of Aspects 51-52, wherein communicating with the UE comprises: receiving a communication from the UE over the physical channel.

Aspect 56: The method of Aspect 55, wherein the physical channel comprises a physical uplink control channel or a physical uplink shared channel.

Aspect 57: The method of any of Aspects 51-56, wherein a time period, between the symbols associated with the full-duplex mode and the symbols associated with the non-full-duplex mode, is null.

Aspect 58: The method of any of Aspects 51-57, wherein the symbols associated with the full-duplex mode are associated with a same frequency resource allocation as the symbols associated with the non-full-duplex mode.

Aspect 59: The method of any of Aspects 51-58, wherein the symbols associated with the full-duplex mode are associated with same spatial relation information as the symbols associated with the non-full-duplex mode.

Aspect 60: The method of any of Aspects 51-58, wherein the symbols associated with the full-duplex mode are associated with a same transmission configuration indicator as the symbols associated with the non-full-duplex mode.

Aspect 61: The method of any of Aspects 51-60, wherein communicating with the UE comprises: transmitting or receiving, for a first frequency hop, in only the symbols associated with the full-duplex mode or only the symbols associated with the non-full-duplex mode; and transmitting or receiving, for a second frequency hop, in only the symbols associated with the full-duplex mode or only the symbols associated with the non-full-duplex mode.

Aspect 62: The method of any of Aspects 51-60, wherein communicating with the UE comprises: transmitting or receiving, for a frequency hop, in the combination of the symbols associated with the full-duplex mode and the symbols associated with the non-full-duplex mode, on a same frequency resource allocation.

Aspect 63: The method of any of Aspects 51-62, wherein communicating with the UE comprises: receiving a nominal repetition using a first actual repetition in the symbols associated with the full-duplex mode and a second actual repetition in the symbols associated with the non-full-duplex mode.

Aspect 64: The method of any of Aspects 51-63, wherein a first actual time domain window, associated with demodulation reference signal bundling, includes the symbols associated with the full-duplex mode, and a second actual time domain window includes the symbols associated with the non-full-duplex mode.

Aspect 65: The method of any of Aspects 51-64, wherein communicating with the UE comprises: transmitting at least one first demodulation reference signal (DMRS) in the symbols associated with the full-duplex mode; and transmitting at least one second DMRS in the symbols associated with the non-full-duplex mode.

Aspect 66: The method of any of Aspects 51-65, wherein a transport block size, associated with communicating with the UE, is calculated using a first quantity of physical resource blocks (PRBs) associated with the symbols associated with the full-duplex mode and a second quantity of PRBs associated with the symbols associated with the non-full-duplex mode.

Aspect 67: The method of any of Aspects 51-66, further comprising: transmitting a first frequency domain resource allocation associated with the symbols that are associated with the full-duplex mode and a second frequency domain resource allocation associated with the symbols that are associated with the non-full-duplex mode.

Aspect 68: The method of any of Aspects 51-67, wherein communicating with the UE comprises: transmitting using rate-matching around an uplink subband in the symbols associated with the non-full-duplex mode.

Aspect 69: The method of Aspect 68, wherein the rate-matching is applied across the symbols associated with the full-duplex mode.

Aspect 70: The method of Aspect 68, where the rate-matching is applied across the combination of the symbols associated with the full-duplex mode and the symbols associated with the non-full-duplex mode.

Aspect 71: An apparatus for wireless communication at a device, comprising a processor; memory coupled with the processor; and instructions stored in the memory and executable by the processor to cause the apparatus to perform the method of one or more of Aspects 1-70.

Aspect 72: A device for wireless communication, comprising a memory and one or more processors coupled to the memory, the one or more processors configured to perform the method of one or more of Aspects 1-70.

Aspect 73: An apparatus for wireless communication, comprising at least one means for performing the method of one or more of Aspects 1-70.

Aspect 74: A non-transitory computer-readable medium storing code for wireless communication, the code comprising instructions executable by a processor to perform the method of one or more of Aspects 1-70.

Aspect 75: A non-transitory computer-readable medium storing a set of instructions for wireless communication, the set of instructions comprising one or more instructions that, when executed by one or more processors of a device, cause the device to perform the method of one or more of Aspects 1-70.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive, from a network, a time domain resource allocation associated with a physical channel that is mapped only to symbols associated with a full-duplex mode or only to symbols associated with a non-full-duplex mode in a slot; and
communicate with the network using the physical channel.

2. The apparatus of claim 1, wherein the full-duplex mode comprises a subband full duplex mode.

3. The apparatus of claim 1, wherein, to communicate with the network, the one or more processors are configured to:
receive a communication from the network over the physical channel.

4. The apparatus of claim 1, wherein, to communicate with the network, the one or more processors are configured to:
transmit a communication to the network over the physical channel.

5. The apparatus of claim 1, wherein, to communicate with the network, the one or more processors are configured to:
drop a communication scheduled across a combination of at least one of the symbols associated with the full-duplex mode and at least one of the symbols associated with the non-full-duplex mode.

6. The apparatus of claim 1, wherein the one or more processors are further configured to:
receive an additional time domain allocation associated with an additional physical channel that is mapped to a combination of symbols associated with the full-duplex mode and symbols associated with the non-full-duplex mode; and
discard the additional time domain allocation.

7. The apparatus of claim 1, wherein a time period, between the symbols associated with the full-duplex mode and the symbols associated with the non-full-duplex mode, is a guard period.

8. The apparatus of claim 7, wherein the time period is the guard period based at least in part on:
the symbols associated with the full-duplex mode preceding symbols associated with non-full-duplex uplink;
the symbols associated with the full-duplex mode following symbols associated with non-full-duplex downlink; or
the symbols associated with the full-duplex mode preceding or following dynamic symbols.

9. The apparatus of claim 7, wherein the one or more processors are further configured to:
drop a communication scheduled during the guard period.

10. The apparatus of claim 1, wherein a time period, between the symbols associated with the full-duplex mode and the symbols associated with the non-full-duplex mode, is null.

11. The apparatus of claim 1, wherein a first actual time domain window, associated with demodulation reference signal bundling, includes the symbols associated with the full-duplex mode and a second actual time domain window includes the symbols associated with the non-full-duplex mode.

12. An apparatus for wireless communication at a network node, comprising:
a memory; and
one or more processors, coupled to the memory, configured to:
transmit a time domain resource allocation associated with a physical channel that is mapped only to symbols associated with a full-duplex mode or only to symbols associated with a non-full-duplex mode in a slot; and
communicate with a user equipment (UE) using the physical channel.

13. The apparatus of claim 12, wherein the full-duplex mode comprises a subband full duplex mode.

14. The apparatus of claim 12, wherein, to communicate with the UE, the one or more processors are configured to:
transmit a communication to the UE over the physical channel.

15. The apparatus of claim 12, wherein, to communicate with the UE, the one or more processors are configured to:
receive a communication from the UE over the physical channel.

16. The apparatus of claim 12, wherein a time period, between the symbols associated with the full-duplex mode and the symbols associated with the non-full-duplex mode, is a guard period.

17. The apparatus of claim 16, wherein the time period is the guard period based at least in part on:
the symbols associated with the full-duplex mode preceding symbols associated with non-full-duplex uplink;
the symbols associated with the full-duplex mode following symbols associated with non-full-duplex downlink; or
the symbols associated with the full-duplex mode preceding or following dynamic symbols.

18. The apparatus of claim 16, wherein the one or more processors are further configured to:
refrain from communicating with the UE during the guard period.

19. The apparatus of claim 12, wherein a time period, between the symbols associated with the full-duplex mode and the symbols associated with the non-full-duplex mode, is null.

20. The apparatus of claim 12, wherein a first actual time domain window, associated with demodulation reference signal bundling, includes the symbols associated with the full-duplex mode and a second actual time domain window includes the symbols associated with the non-full-duplex mode.

21. An apparatus for wireless communication at a user equipment (UE), comprising:
a memory; and
one or more processors, coupled to the memory, configured to:
receive, from a network, a time domain resource allocation associated with a physical channel that is mapped to a combination of symbols associated with a full-duplex mode and symbols associated with a non-full-duplex mode in a slot; and
communicate with the network using the physical channel.

22. The apparatus of claim 21, wherein the full-duplex mode comprises a subband full duplex mode.

23. The apparatus of claim 21, wherein, to communicate with the network, the one or more processors are configured to:
receive a communication from the network over the physical channel.

24. The apparatus of claim 21, wherein, to communicate with the network, the one or more processors are configured to:
transmit a communication to the network over the physical channel.

25. The apparatus of claim 21, wherein a time period, between the symbols associated with the full-duplex mode and the symbols associated with the non-full-duplex mode, is null.

26. The apparatus of claim 21, wherein the symbols associated with the full-duplex mode are associated with a same frequency resource allocation, same spatial relation information, or a same transmission configuration indicator, as the symbols associated with the non-full-duplex mode.

27. The apparatus of claim 21, wherein, to communicate with the network, the one or more processors are configured to:
receive from the network using rate-matching around an uplink subband in the symbols associated with the non-full-duplex mode.

28. An apparatus for wireless communication at a network node, comprising:
a memory; and
one or more processors, coupled to the memory, configured to:
transmit a time domain resource allocation associated with a physical channel that is mapped to a combination of symbols associated with a full-duplex mode and symbols associated with a non-full-duplex mode in a slot; and
communicate with a user equipment (UE) using the physical channel.

29. The apparatus of claim 28, wherein the full-duplex mode comprises a subband full duplex mode.

30. The apparatus of claim 28, wherein, to communicate with the UE, the one or more processors are configured to:
transmit a communication to the UE over the physical channel; or
receive a communication from the UE over the physical channel.
